(19) United States
(12) Patent Application Publication
(10) Pub. No.: US 2025/0164381 A1
(43) Pub. Date: May 22, 2025

(54) LINE SCANNING FOR COMPACT CELL SORTERS AND COMPACT FLOW CYTOMETERS

(71) Applicant: CYTEK BIOSCIENCES, INC., Fremont, CA (US)

(72) Inventors: Bing Shan, Fremont, CA (US); Ming Yan, Fremont, CA (US); Han Zhang, Fremont, CA (US)

(73) Assignee: CYTEK BIOSCIENCES, INC., Fremont, CA (US)

(21) Appl. No.: 18/951,489

(22) Filed: Nov. 18, 2024

Related U.S. Application Data
(60) Provisional application No. 63/600,651, filed on Nov. 18, 2023.

(51) Int. Cl. G01N 15/149; G01N 15/10; G01N 15/14; G01N 15/1429; G01N 15/1434

(52) U.S. Cl. CPC G01N 15/149; G01N 15/1429; G01N 15/1434; G01N 15/1459; G01N 2015/1006; G01N 2015/144

(57) ABSTRACT

A flow cytometer or cell sorting system includes a linear array detector having a plurality of detectors; a plurality of low noise gain amplifiers respectively coupled to the plurality of detectors in the linear array detector; a plurality of analog to digital converters respectively coupled to the plurality of detectors of the linear array detector; and image reconstruction logic coupled to the plurality of analog to digital converters. The linear array detector receives the brightfield image of each cell of the plurality of biological cells and transduces the light into analog signals representative of pixels in a plurality of brightfield image lines of each cell. The plurality of analog to digital converters transduce the analog signals into digital numeric signals for each pixel. The image reconstruction logic reconstructs the plurality of brightfield image lines of each cell over time periods into a single overall brightfield image of each cell.

### CROSS-REFERENCE TO RELATED APPLICATIONS

This patent application claims the benefit of U.S. Provisional Patent Application No. 63/600,651, titled LINE SCANNING FOR COMPACT CELL SORTERS filed on Nov. 18, 2023, by inventors Bing Shan et al., incorporated herein by reference for all intents and purposes.

This patent application incorporates by reference U.S. patent application Ser. No. 17/665,480 titled INTEGRATED COMPACT CELL SORTER filed on Feb. 4, 2022, by inventors Glen Krueger et al., for all intents and purposes.

### FIELD

The embodiments of the invention relate generally to flow cytometer and cell sorter systems.

### BACKGROUND

Flow cytometry and cell sorting involves the optical measurement of cells or particles of a test sample carried in a fluid flow. Cell sorting further sorts out selected cells of interest into different containers (e.g., test tubes) for further usage (e.g., testing) or counting. The lab instruments that achieve these tasks are known as a flow cytometer and a cell sorter, also referred to as a sorting flow cytometer.

Cells or other particles are often stained or marked with a fluorochrome that can attach to the cell or other particle at a marker in the sample. Different fluorochromes can be excited by different laser light of different center wavelengths to better identify unknown cells and particles in the test sample. Photodetectors can be used to detect different fluorescence of the different fluorochromes.

However, the fluorescence of the different fluorochromes marking cells does not give a clear image of each cell or particle. Accordingly, in addition to detecting fluorescence of the different fluorochromes, it can be desirable to capture images of cells and particles at lower costs over prior methods and systems of doing so in order to perform further analysis over the cells and particles with different imaging modalities.

### SUMMARY

The embodiments are best summarized by the claims. However, a summary of some of the embodiments is provided here. In some aspects, the techniques described herein relate to an electro-optic imaging system for a flow cytometer or cell sorter system, the electro-optic imaging system including: a flow cell/cuvette through which a sheath fluid and a sample fluid flow in a stream with a plurality of biological cells aligned in the stream of the sample fluid; a laser to generate a broad spectrum of light coupled into one side of an interrogation region of the flow cell/cuvette to back light each cell of the plurality of biological cells; an optical subsystem on an opposite side of the interrogation region to receive a brightfield image of each cell of the plurality of biological cells formed by the back light and a forward scattered light; a linear array detector (also sometimes referred to as a linear detector array) having a plurality of detectors, the linear array detector to receive the brightfield image of each cell of the plurality of biological cells formed by the back light from the optical subsystem, the linear array detector to transduce light into analog signals representative of pixels in a plurality of brightfield image lines of each cell; a plurality of low noise gain amplifiers respectively coupled to the plurality of detectors in the linear array detector; a plurality of analog to digital converters respectively coupled to the plurality of detectors of the linear array detector to receive analog signals representative of each pixel in each brightfield image line, the plurality of analog to digital converters to transduce the analog signals into digital numeric signals for each pixel in each brightfield image line; and image reconstruction logic coupled to the plurality of analog to digital converters to receive the digital numeric signals representing each pixel in each brightfield image line, the image reconstruction logic to reconstruct the plurality of brightfield image lines of each cell over time periods into a single overall brightfield image of each cell.

In some aspects, the techniques described herein relate to a system, further including: a mask over the linear array detector, the mask having a linear slot to allow a line of light to pass through onto the detectors in the linear array detector.

In some aspects, the techniques described herein relate to a system, wherein the optical subsystem includes a first lens to collimate the forward scattered light and the back light forming the brightfield image; a second lens to focus the forward scattered light and the back light forming the brightfield image to a focal point; and a third lens to magnify the back light and the brightfield image to spread the brightfield image over the plurality of detectors of the linear array detector.

In some aspects, the techniques described herein relate to a system, further including: a processor executing instructions of cellular image artificial intelligence software to recognize cells and features of cells in each single overall brightfield image of each cell.

In some aspects, the techniques described herein relate to a system, further including: a forward scatter detector to detect boundaries of each cell from the forward scattered light; and wherein the optical subsystem includes a flat mirror with a center opening aligned with an optical axis, the flat mirror configured to reflect forward scattered light to the forward scatter detector and to allow light representing a brightfield image of the cell to pass through the center opening to the linear array detector.

In some aspects, the techniques described herein relate to a system, further including: a forward scatter detector aligned with an optical axis to detect boundaries of each cell from the forward scattered light; and wherein the optical subsystem includes a central mirror to reflect light representing a brightfield image of each cell to the linear array detector and to allow forward scattered light to pass by the central mirror to the forward scatter detector.

In some aspects, the techniques described herein relate to a system, further including: a storage device in communication with the plurality of analog to digital converters to store digital signals representing each different image line of each cell; and wherein the forward scatter detector captures a focused forward scattered (FS) light signal indicating the start of a boundary of each cell and generates a trigger signal; and the trigger signal triggers the plurality of low noise gain amplifiers to amplify signals, the plurality of analog to digital converters to convert analog signals into digital signals, and the storage device to store the digital signals.

In some aspects, the techniques described herein relate to a system, wherein: the forward scatter detector detects a loss of the focused forward scattered (FS) light signal indicating the end of another boundary of each cell and stops the generation of the trigger signal; and the absence of the forward scatter light signal ends the amplification of signals by the plurality of low noise gain amplifiers, the conversion of analog signals by the plurality of analog to digital converters, and the storage of digital signals by the storage device until a boundary of a next cell is detected.

In some aspects, the techniques described herein relate to a system, further including: a storage device in communication with the plurality of analog to digital converters to store digital signals representing each different image line of each cell; and wherein the forward scatter detector captures a focused forward scattered (FS) light signal indicating the start of a boundary of each cell and generates a trigger signal; and the trigger signal triggers the plurality of low noise gain amplifiers to amplify signals, the plurality of analog to digital converters to convert analog signals into digital signals, and the storage device to store the digital signals.

In some aspects, the techniques described herein relate to a system, wherein: the forward scatter detector detects a loss of the focused forward scattered (FS) light signal indicating the end of another boundary of each cell and stops the generation of the trigger signal; and the absence of the trigger signal ends the amplification of signals by the plurality of low noise gain amplifiers, the conversion of analog signals by the plurality of analog to digital converters, and the storage of digital signals by the storage device until a boundary of a next cell is detected.

In some aspects, the techniques described herein relate to a system, wherein: wherein the image reconstruction logic includes one or more frame buffers coupled to a signal processor, wherein the signal processor executes instructions to reconstruct the plurality of brightfield image lines of each cell over time periods into a single overall brightfield image of each cell.

In some aspects, the techniques described herein relate to a method for a flow cytometer system, the method including: flowing a plurality of biological cells aligned in a stream of a sample fluid in a flow cell; directing a laser light into one side of an interrogation region of the flow cell/cuvette to back light each cell of the plurality of biological cells; receiving a brightfield image of each cell of the plurality of biological cells formed by the back light and a forward scattered light; separating the forward scattered light from the brightfield image for each cell of the plurality of biological cells formed by the back light; with a linear array detector having a plurality of detectors, receiving the brightfield image of each cell and transducing the back light into analog signals representative of pixels in a plurality of brightfield image lines of each cell over a plurality of time periods; amplifying and converting the analog signals representing each pixel into digital numeric signals for each pixel in each brightfield image line; and reconstructing the plurality of brightfield image lines of each cell over the plurality of time periods into a single overall brightfield image of each cell.

In some aspects, the techniques described herein relate to a method, further including prior to the reconstructing, detecting a focused forward scattered (FS) light signal indicating the start of a boundary of each cell to generate a trigger signal; and storing the digital numeric signals for each pixel of each brightfield image line into a storage device based on the trigger signal.

In some aspects, the techniques described herein relate to a method, further including prior to the reconstructing, for each brightfield image line, justifying the digital numeric signals and assembling the digital numeric signals into an event of a given time period.

In some aspects, the techniques described herein relate to a method, further including with cellular image artificial intelligence software recognizing cells and features of cells in each single overall brightfield image of each cell.

In some aspects, the techniques described herein relate to a method, further including based on the recognition of each cell from each single overall brightfield image, generating a sorting command to sort each cell into a plurality of test tubes or a plurality of wells of a well plate.

In some aspects, the techniques described herein relate to a method, further including prior to the receiving of the bright field image of each cell, magnifying the back light and brightfield image to spread the brightfield image over the plurality of detectors of the linear array detector.

In some aspects, the techniques described herein relate to an electro-optic imaging system for a flow cytometer or cell sorter system, the electro-optic imaging system including: a flow cell/cuvette through which a sheath fluid and a sample fluid flow in a stream with a plurality of biological cells aligned in the stream of the sample fluid; a laser to generate a spectrum of light around a center wavelength coupled into one side of an interrogation region of the flow cell/cuvette to provide a back light for each cell of the plurality of biological cells; an optical subsystem on an opposite side of the interrogation region to receive a brightfield image of each cell of the plurality of biological cells formed by the back light and a forward scattered light; a plurality of linear array detectors each having a plurality of detectors, each of the plurality of the linear array detectors to receive the brightfield image of each cell of the plurality of biological cells from the optical subsystem, wherein the plurality of array detectors are temporarily offset from each other generating different brightfield image lines for each time period, wherein the odd linear array detectors are spatially offset by a fraction of a pixel from the even linear array detectors in the plurality, wherein each linear array detector of the plurality to transduce light into analog signals representative of pixels in a plurality of brightfield image lines of each cell; a plurality of multichannel low noise gain amplifiers respectively coupled to the plurality of linear array detectors; a plurality of multichannel analog to digital converters respectively coupled to the plurality of multichannel low noise gain amplifiers to receive amplified analog signals representative of each pixel in each brightfield image line, the plurality of multichannel analog to digital converters to transduce the analog signals into digital numeric signals for each pixel in each brightfield image line captured by each of the plurality of linear array detectors; a plurality of input frame buffers respectively coupled to the plurality of multichannel analog to digital converters to receive and store the digital numeric signals for each pixel in each brightfield image line captured by each of the plurality of linear array detectors over a plurality of time periods; and image reconstruction logic coupled to the plurality of input frame buffers to access the digital numeric signals representing each pixel in each brightfield image line, the image reconstruction logic to reconstruct the plurality of brightfield image lines of each cell over the time periods into a single overall brightfield image of each cell.

In some aspects, the techniques described herein relate to a system, further including: a plurality of masks respectively over the plurality of linear array detectors, each of the plurality of masks having a linear slot to allow a line of light to pass through onto the detectors in the linear array detector.

In some aspects, the techniques described herein relate to a system, wherein the image reconstruction logic includes a signal processor in communication with the plurality of input frame buffers, wherein the signal processor executes instructions to dither and interpolate over the digital numeric signals for each pixel in each brightfield image line in order to reconstruct the plurality of brightfield image lines of each cell over time periods into a single overall brightfield image of each cell.

### BRIEF DESCRIPTIONS OF THE DRAWINGS

Various embodiments are illustrated by way of example, and not by way of limitation, in the Figures of the accompanying drawings.

FIG. 1 is a basic conceptual diagram of a cell sorter system (a sorting flow cytometer system), and a flow cytometer system is shown.

FIG. 2 is a perspective view of a flow cell in the fluidics subsystem of a compact cell sorter system.

FIGS. 3A-3B are views of the deflection unit of the sorting subsystem of a compact cell sorter system.

FIGS. 4A-4C illustrate an image capture process for a moving cell (or flowing cell) in a sample over an electro-optical subsystem with a linear array detector.

FIG. 4D is a block diagram of a processor interfacing between two or more sets of frame buffers to transpose and process pixel data.

FIGS. 5A-5B illustrate an image capture process for a moving cell (or flowing cell) in a sample over an electro-optical subsystem including a sensor array with a plurality of linear array detectors and associated aperture devices.

FIG. 6 illustrates a cell sorting system that uses bright field imaging of moving cells captured by a linear array detector to perform cell sorting.

FIG. 7 illustrates a top view of an electro-optical subsystem for a flow cytometer to capture images of the moving cell from a fluorescence light signal or a side scattered light signal.

FIG. 8 illustrates a top view of another electro-optical subsystem for a flow cytometer to capture images of a moving cell from a fluorescence light signal or a side scattered light signal.

FIG. 9 illustrates a block diagram of a cell image analysis subsystem for a flow cytometer after digital images are captured.

FIG. 10A illustrates a top view of a linear array detector and linear aperture device that can be used with the electro-optical subsystems to capture brightfield image lines of a moving biological cell in a biological sample.

FIG. 10B illustrates a side view of a linear array detector shown in FIG. 10A to capture an image line of the magnified image of the moving biological cell in the biological sample.

It will be recognized that some or all of the Figures are for purposes of illustration and do not necessarily depict the actual relative sizes or locations of the elements shown. The Figures are provided for the purpose of illustrating one or more embodiments with the explicit understanding that they will not be used to limit the scope or the meaning of the claims.

### DETAILED DESCRIPTION

In the following detailed description of the embodiments, numerous specific details are set forth. However, it will be obvious to one skilled in the art that the embodiments may be practiced without these specific details. In other instances, well known methods, procedures, components, and circuits have not been described in detail so as not to unnecessarily obscure aspects of the embodiments. The various sections of this description are provided for organizational purposes. However, many details and advantages apply across multiple sections.

### System Overview

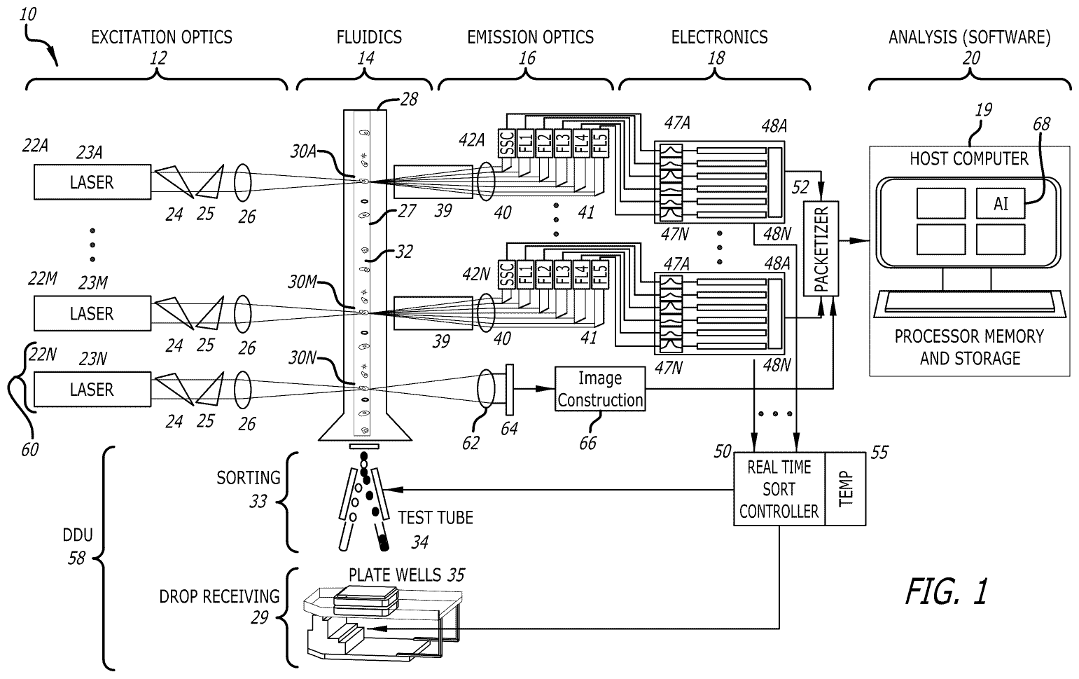

FIG. 1 is a basic conceptual diagram of a cell sorter system (sorting flow cytometer) 10. Five major subsystems of the system 10 include an excitation optics system 12, a fluidics system 14, an emission optics system 16, an acquisition system 18, and an analysis system 20. The fluidics system 14 can include a sample loading system (not shown), an interrogating system (flow cell/cuvette) 28, a cell sorting system 33, and a drop receiving system 29. Generally, a “system” and “subsystem” includes (electrical, mechanical, and electro-mechanical) hardware devices, software devices, or a combination thereof. While a cell sorter system is described, the disclosure also applies to flow cytometer systems.

The excitation optics system 12 includes, for example, a plurality (e.g., two to five) of excitation channels 22A-22N each having a different laser device 23A-23N and one or more optical elements 24-26 to direct the different laser light to optical interrogation regions 30A-30N spaced apart along a line in a flow channel 27 of a flow cell/cuvette 28. Example optical elements of the one or more one or more optical elements 24-26 can include an optical prism and an optical lens. The excitation optics system 12 illuminates an optical interrogation region 30 in the flow cell/cuvette 28. The fluidics system 14 carries a fluid sample 32 with biological cells or particles surrounded by a sheath fluid through each of a plurality of optical interrogation regions 30A-30N in a flow channel of the flow cell/cuvette 28.

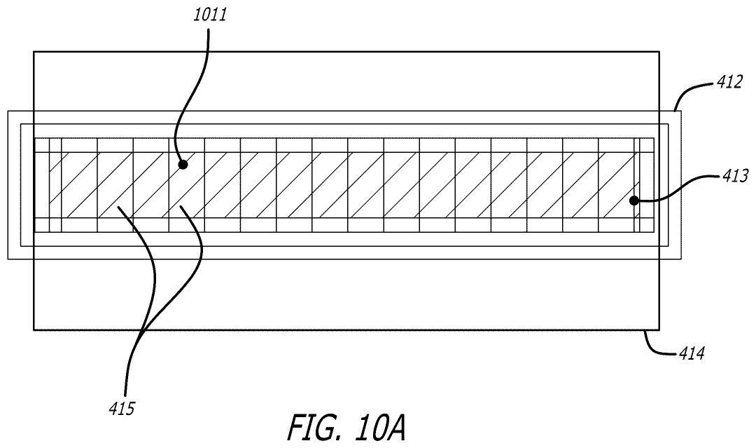

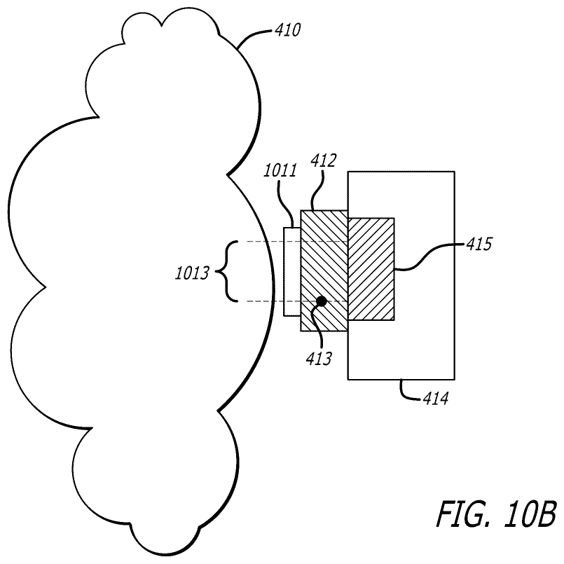

A standard flow cytometer can be adapted at low costs to capture brightfield images of cells and particles. One excitation channel 22N can be used as white light to illuminate the biological cells or particles in the sample for capturing a brightfield image of cells or particles. The cells or particles are backlit by the white light. One or more lenses 62 magnify the brightfield image of the cells or particles as the flow down the column for capture by a linear array detector 64, sometimes referred to as a linear array detector. A linear mask or linear aperture device 412 with a linear slot (see slot 413 of linear aperture device 412 for the linear array detector 414 shown in FIG. 10A) between the lens 62 and the linear array detector 64 assures that a plurality of brightfield image lines are captured over time periods by the linear array detector 64 as each biological cell flows by in the biological sample. Piecing or stitching the plurality of brightfield image lines together that are captured by the linear array detector 64 can provide an inexpensive method of capturing a full brightfield image of the biological cell. The linear array detector may be W channels wide capturing W pixels at each time period. An image construction subsystem 66 pieces or stitches the brightfield image lines of a cell together, captured over time, to complete a single brightfield image of each cell. The brightfield image of each cell can be passed to a host computer 19 or processor such as in data packet form by a packetizer 52. The host computer 19 or processor executes an artificial intelligence image analysis process 68 to carefully examine the brightfield image, fluorescence, and/or side scatter light from each cell or particle. A processor, such as a signal processor or other logical circuitry, can be embedded in a flow cytometer or cell sorter so that real time analysis can be performed on call images that are captured.

For the fluorescence channels, the emission optics system 16 includes a plurality of linear array detectors 42A-42N each of which, for example, includes one or more optical elements 40, such as an optical fibre and one or more lenses to direct fluorescent light and/or (forward, side, back) scattered light to various electro-optical detectors (transducers), including a side scatter (SSC) channel detector and a plurality (e.g., 16, 32, 48, 64) of fluorescent wavelength range optical detectors in each array, such as a first fluorescent optical detector (FL1) receiving a first wavelength range of fluorescent light, a second fluorescent optical detector (FL2) receiving a second wavelength range of fluorescent light, a third fluorescent optical detector (FL3) receiving a third wavelength range of fluorescent light, a fourth fluorescent optical detector (FL4) receiving a fourth wavelength range of fluorescent light, a fifth fluorescent optical detector (FL5) receiving a fifth wavelength range of fluorescent light, and so on to an Nth fluorescent optical detector (FLN) receiving an Nth wavelength range of fluorescent light. Each of the linear array detectors 42A-42N receives light corresponding to the cells/particles that are struck and/or one or more fluorescent dyes that attached thereto and excited by the differing laser light in interrogation regions/points 30A-30N along the flow channel 27 of the flow cell/cuvette 28 by each of the corresponding plurality of lasers 23A-23N. The emission optics system 16 gathers photons emitted or scattered from passing cells/particles and/or a fluorescent dyes attached to the cells/particles. The emission optics system 16 directs and focuses these collected photons onto the electro-optical detectors SSC, FL1, FL2, FL3, FL4, and FL5 in each linear array detector, such as by fiber optic (optical fibre) cables 39, one or more one or more lenses 40, and one or more mirrors/filters 41. Electro-optical detector SSC is a side scatter channel detector detecting light that scatters off the cell/particle. The electro-optical detectors FL1, FL2, FL3, FL4, and FL5 are fluorescent detectors may include band-pass, or long-pass, filters to detect a particular and differing fluorescence wavelength ranges from the different fluorescent dyes excited by the different lasers. Each electro-optical detector converts photons into electrical pulses and sends the electrical pulses to the acquisition (electronics) system 18.

For each linear array detector 42A-42N, the acquisition (electronics) system 18 includes one or more analog to digital converters 47A-47N and one or more digital storage devices 48A-48N that can provide a plurality of detector channels (e.g., 16, 32, 48 or 64 channels) of spectral data signals. The spectral data signals can be signal processed (e.g., digitized by the A/Ds) and time stamped, and packeted together by a packetizer 52 into a data packet corresponding to each cell/particle in the sample). These data packets for each cell/particle can be sent by the acquisition (electronics) system 18 to the analysis system 20 for further signal processing (e.g., converted/transformed from time domain to wavelength domain) and overall analysis. Alternatively, or conjunctively, time stamped digital spectral data signals from each channel that is detected can be directly sent to the analysis system 20 for signal processing.

The analysis system 20 includes a processor, memory, and data storage to store the data packets of time stamped digital spectral data associated with the detected cells/particles in the sample. The analysis system 20 further includes software with instructions executed by the processor to convert/transform data from the time domain to data in a wavelength/frequency domain and stich/merge data together to provide an overall spectrum for the cell/particle/dyes excited by the different lasers and sensed by the linear array detectors. With detection of the type of cell/particle through the one or more fluorescent dyes attached thereto, a count of the cells/particles can be made in a sample processed by a flow cytometer and/or cell sorter.

In some cases, it is desirable to sort out the cells in a sample for further analysis with a cell sorter (sorting flow cytometer). Accordingly, the spectral data signals can also be processed by a real time sort controller 50 in the acquisition (electronics) system 18 and used to control a sorting system 33 to sort cells or particles into one or more test tubes 34. In which case, the sorting system 33 is in communication with the real time sort controller 50 of the acquisition (electronics) system 18 to receive control signals. Instead of test tubes 34, the spectral data signals can also be processed by the real time sort controller 50 of the acquisition (electronics) system 18 and used to control both the sorting system 33 and a droplet deposition system 29 to sort cells or particles into wells 35 of a moving capture tray/plate. In which case, both the droplet deposition system 29 and the sorting system 33 are in communication with the acquisition (electronics) system 18 to receive control signals. In an alternate embodiment, the analysis system 20 can generate these control signals from analyzing the spectral data signals in order to sort out different cells/molecules and control the sorting system 33 and the droplet deposition system 29 to capture the drops of samples with cells/particles into one or more wells 35 of the plurality of wells in the capture tray/plate.

U.S. patent application Ser. No. 15/817,277 titled FLOW CYTOMETERY SYSTEM WITH STEPPER FLOW CONTROL VALVE filed by David Vrane on Nov. 19, 2017, now issued as U.S. patent Ser. No. 10/871,438; U.S. patent application Ser. No. 15/659,610 titled COMPACT DETECTION MODULE FOR FLOW CYTOMETERS filed by Ming Yan et al. on Jul. 25, 2017; and U.S. patent application Ser. No. 15/942,430 COMPACT MULTI-COLOR FLOW CYTOMETER HAVING COMPACT DETECTION MODULE filed by Ming Yan et al. on Mar. 30, 2018, each of which disclose exemplary flow cytometer systems and subsystems all which are incorporated herein by reference for all intents and purposes. U.S. Pat. No. 9,934,511 titled RAPID SINGLE CELL BASED PARALLEL BIOLOGICAL CELL SORTER issued to Wenbin Jiang on Jun. 19, 2016, discloses a cell sorter system that is incorporated herein by reference for all intents and purposes.

### Flow Cell Assembly

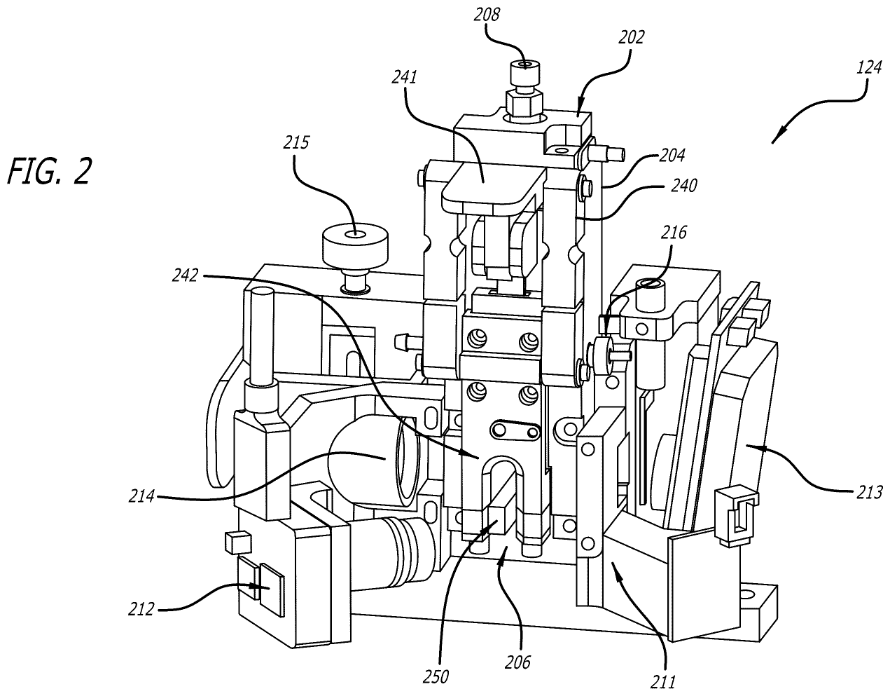

FIG. 2 illustrates various components of the flow cell assembly 124 for a cell sorter. The flow cell assembly 124 includes a drop drive assembly 202, the nozzle assembly 250 and nozzle carriage assembly 242 a carriage release lever 241 of a flow cell linkage assembly 240. The flow cell 124 further has a number of optical components including a drop camera for 212, drop strobe assembly 211, forward scatter assembly 213, and a final focus lens 214. The final focus lens 214 can be focused by a final focus adjustment 215. The drop drive assembly 202 has a sample input port 208 to receive a hose or pipe that carries the sample fluid.

The flow cell 124 includes a flow cell body 204, a drop drive assembly 202, a cuvette 206, a linkage assembly 240, a carriage assembly 242, and a nozzle assembly 250 with a nozzle (not shown in FIG. 2). The linkage assembly 240 includes a carriage release lever 241 that pivots to move the nozzle assembly up and down with respect to the cuvette 206. The drop drive assembly 202 includes a sample injection tube 222.

Laser light from one or more lasers is sent into one or more interrogation regions in the flow channel of a cuvette to excite flowing cells/particles and/or one or more fluorescent dye markers attached thereto that pass by. The flow cell 124 further includes one or more objective lenses in order to capture light (e.g., reflected light, scattered light, fluorescent light) from the cells/particles and/or the one or more fluorescent dyes attached to the cells/particles on one side. On an opposite side, the one or more objective lenses can launch the captured light into a fiber optic cable and/or direct it towards a forward scatter detector and/or the linear aperture device 412 and the linear array detector subassembly 494,594,694.

A nozzle, in the nozzle assembly 250 of the flow cell 124, breaks up the sample fluid into spaced droplets in air out of the cuvette. The droplets with cells of interest in a center stream are sorted out by deflecting the droplets away from the center stream. The droplets with cells of interest are charged in the flow cell so they can be deflected away from the center stream by charged deflecting plates in the deflection chamber of the droplet deflection unit 122. The droplets with cells of interest can be collected into separate vessels (test tubes, wells) by a droplet deflection unit for further testing in a lab.

### Deflection Chamber

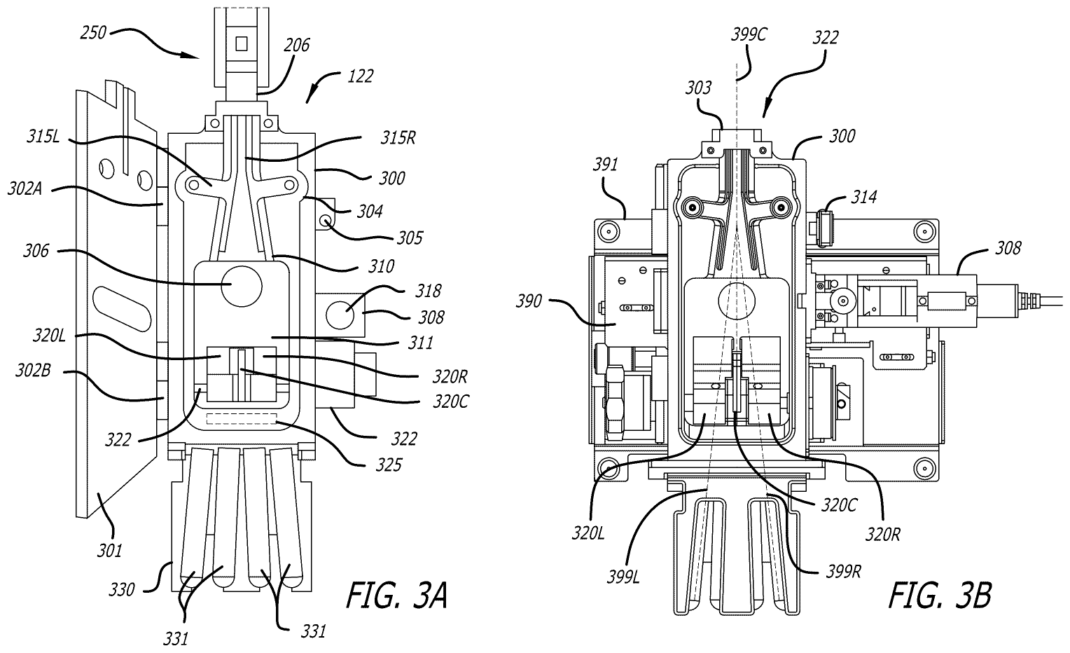

FIGS. 3A-3B illustrate the droplet deflection unit 122 under nozzle assembly 250 of the flow cell 124. Accordingly, the droplet deflection unit is in communication with the flow cell 124 to receive a plurality of drops of the sample biological fluid that are in a center stream. The back of the deflection unit 122 is mounted to a rail so that it can be horizontally adjusted from side to side.

The droplet deflection unit 122 includes a case 300 with a door 301 pivotally coupled to the case by a plurality of hinges 302A-302B. The door 301 includes a fastener (e.g., a catch) that can engage a latch to keep the door securely closed against the case. The case 300 has a deflection cone cutout 310 that opens up into a deflection chamber 311. A seal 304 is in a channel around the deflection cone cutout 310 and the deflection chamber 311 to which the door 301 presses against. This seals the sample drops within the cutout and chamber, so they are not released into ambient air.

A left electrostatic charge (deflection) plate 315L and a right electrostatic charge (deflection) plate 315R are mounted in the deflection cone cutout 310 and are progressively separated further from each other from top to bottom in the cone. A left high voltage charge is applied to the left electrostatic charge plate 315L, and a right high voltage charge of opposite polarity is applied the right electrostatic charge plate 315R to impose an electrostatic charge field through which droplets pass. If a drop is to be sorted by moving it away from a center stream of drops, a positive charge or a negative charge is synchronously applied to a drop by the conductive hose fitting in the drain/charge port and a charge signal from the sort controller. If the droplets are uncharged (grounded), they remain in the center stream. Only if a droplet is charged, by applying a charge signal (positive or negative) to the charge port on the flow cell, will it be deflected as it passes through the electro static charge field formed by the electrostatic charge plates. The degree of deflection depends on both the magnitude of the electrostatic charge field imparted by the left and right electrostatic charge plates and the polarity and magnitude of the charge imparted to the droplet by the charge port.

For example, the left electrostatic charge plate may be charged at negative 2000 Volts and the right electrostatic charge plate may be charged at positive 2000 volts to provide a 4000 volt electrostatic field between them. The voltages on the electrostatic charge plates are held constant during a sort of droplets in a sample. Droplets then may be selectively charged instantaneously (by applying charge to the conductive hose fitting in the charge/drain port on the flow cell) to achieve a desired deflection away from center. Accordingly, the precise magnitude and polarity of voltage applied to cells associated with each stream path will depend on the desired direction and magnitude of deflection needed to get the droplet into a receiving receptacle. Accordingly, multiple (e.g., 2, 3, 4, 5, 6) left deflected stream paths and multiple (e.g., 2, 3, 4, 5, 6) right deflected stream paths can be formed about the center stream path. For simplicity of the explanation herein, we will collectively refer to them herein as a left stream path (left stream) and a right stream path (right stream).

A backside of the case 300 has a side laser window and a stream camera window 306. A side laser light generated by a laser 308 is directed into the deflection chamber 311 through the side laser window. The position of the laser 308 behind the side laser window can be adjusted by the laser position adjuster 318. The side laser light is adjusted front to back to strike the drops of biological fluid to sense the path position of the drops. A stream camera 307 is mounted outside the case in line with and behind the stream camera window 306 to view the drops and determine whether or not they are in a center stream path, a left deflected stream path, or a right deflected stream path. The stream camera 307 provides a feedback mechanism to the sort controller to be sure the charges on the charge plates are appropriate for deflection of drops into the left deflected stream path and the right deflected stream path, as well as equally charged (or no charge) for dropping in the center stream path inside the deflection unit 122.

At the base of the deflection chamber 311 is an aspirator well (tub) with a drain to aspirate drops into the waste line out of the cell sorter. In front and below the tub in the base of the deflection chamber is a horizontal drop slot 325. Inside the deflection chamber 311, a left pivotal side stream scupper 320L, a non-pivotal center collector 320C, and a right pivotal side stream scupper 320R are mounted along a drive shaft 322 in the tub of the deflection chamber. The non-pivotal center collector 320C is around the drive shaft between the left and right pivotal sidestream scuppers but is undriven by the drive shaft. The left pivotal sidestream scupper and the right pivotal sidestream scupper pivot with the drive shaft between a raised position and a lowered position. The non-pivotal center collector 320C is non-pivotal and remains in a fixed rotational position regardless but is free to move left and right with the scuppers. Drops that are deflected and not captured by the side stream scuppers 320L-320R or the non-pivotal center collector 320C, can fall out of the deflection unit 122 through the drop slot 325.

With no deflection by the deflection plates, the center stream of drops from the nozzle assembly drop through the deflection cone 310 into the deflection chamber 311 and are caught by the non-pivotal center collector 320C. The non-pivotal center collector 320C and the side stream scuppers 320L-320R, when in the lowered position, act somewhat like rain gutters directing the flow of drops of sample fluid. The non-pivotal center collector 320C directs the drops it catches into the tub for aspiration down the drain as waste. In a lowered position, the left and right pivotal side stream scuppers 320L-320R catch drops that are deflected away from the center stream and direct the drops they catch by means of a tunnel into the tub for aspiration down a drain as waste. The drops in the tub can be aspirated down the drain and out through a waste port by a vacuum.

In a raised position, the left and right pivotal side stream scuppers 320L-320R do not catch any drops. When left and right pivotal sidestream scuppers are in the raised position and selected drops are deflected away from the center stream as deflected drops, those deflected drops of sample fluid drop past the sidestream scuppers and through the drop slot 325 in the base of the case 300. The deflected drops pass through the drop slot 325 for collection in a chamber with a well plate or test tubes below the deflection unit 122.

In the case of an urgent sorter shutdown, the sorter 100 pivots the shaft and the sidestream scuppers into the lowered position such that they and the non-pivotal center collector 320C catch all drops of sample fluid formed by the nozzle assembly 250, whether deflected or not, and direct the drops into the tub 352 for aspiration down the drain and out the waste port.

Ends of the drive shaft 322 extend outside the deflection chamber 311. A scupper pulley 323 is mounted to the shaft 322 near one end (e.g., right end). A reversable electric motor has a shaft with appropriately sized drive pulley. A belt 324 is mounted between the drive pulley and the scupper pulley to pivot the shaft in response to the rotation by the reversable electric motor and raise or lower the sidestream scuppers.

The deflection unit (chamber) 122 is horizontally adjustable. The deflection unit 122 can be slidingly mounted to a rail and horizontally adjustable from side to side, in order to adjust its position to the center stream path of drops that enter at a top opening. The deflection unit 122 can be horizontally adjusted so that the center stream of drops is selectively positioned (equidistant or as otherwise desired) between the left electrostatic charge plate 315L and the right electrostatic charge 315R plate as the drops enter the deflection cone cutout 310.

Because the drops can be initially charged and the charge plates may unequally influence entering drops, the left pivotal side stream scupper 320L, the non-pivotal center collect 320C, and the right pivotal side stream scupper 320R are horizontally adjustable together from side to side together. An adjustment knob 327 is provided to horizontally adjust the position of the scuppers 320L-320R and the non-pivotal center collector 320C together along a drive shaft 322. Accordingly, without charges deflecting the stream of drops, the center non-pivotal collector 320C can be centered under the center stream of drops of sample fluid with an adjustment to direct them into the tub and down the drain for aspiration out from the cell sorter through the waste outlet.

As mentioned herein, the deflected drops pass through the drop slot 325 in the case 300 for collection in the drop collection chamber 128 below the deflection unit 122. Coupled to the base of the case 300 of the deflection unit 122 is a collection retainer 332 in the drop collection chamber 128. A sort collection holder 330 can be slid into the collection retainer 332 in the drop collection chamber 128. A plurality of test tubes 34, such as shown in FIG. 1, may be inserted into the openings 331 in the sort collection holder 330 to receive the drops sorted out by the cell sorter. As shown in FIG. 3A, the openings 331 are aligned (front to back in depth) with the drop slot 325 such that test tubes mounted therein can capture drops of sample fluid.

Drops in one or more left deflected stream paths may be received in test tubes to the left of center. Drops in one or more right deflected stream paths may be received in test tubes to the right of center. FIG. 3A illustrates a four-tube sort collection holder 330 coupled to the base of the case 300 with four openings 331 to hold four test tubes, two test tubes to receive drops in two left deflected stream paths and two test tubes to receive drops in two right deflected stream paths.

A plate guide can be used instead of a tube collection retainer. The plate guide has a one or more stream path openings in which selected drops fall through and out of the plate guide. A plate 35, such as shown in FIG. 1, with a plurality of wells is moved around underneath the plate guide by the loading system to catch drops in the one or more wells. A plate can have a plurality of wells (e.g., 32 or 64) in which to capture drops with different types of cells/particles. The plate is moved to align one or more selected wells underneath the respective one or more stream path openings to receive the drops of sample fluid with the desired cells/particles.

With this introduction of cell sorting, the use of linear array detectors is now discussed for the capture of images of moving cells in the cuvette of the flow cell.

### Image Capture

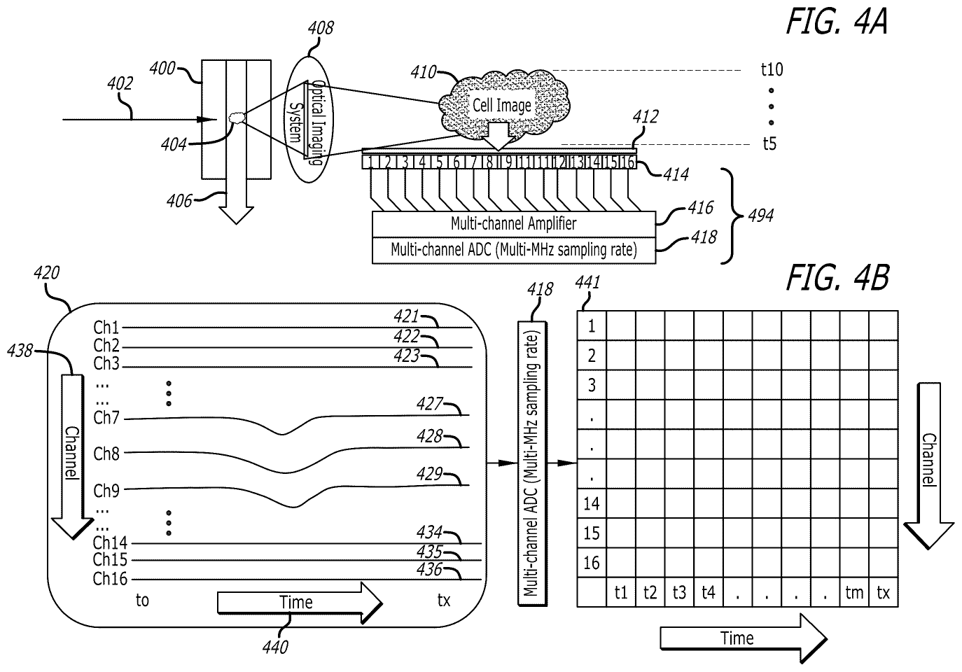

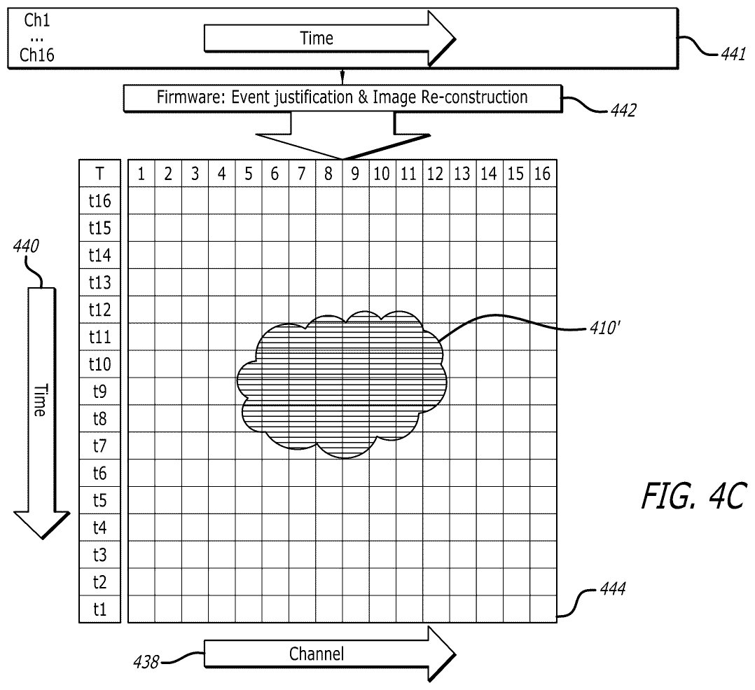

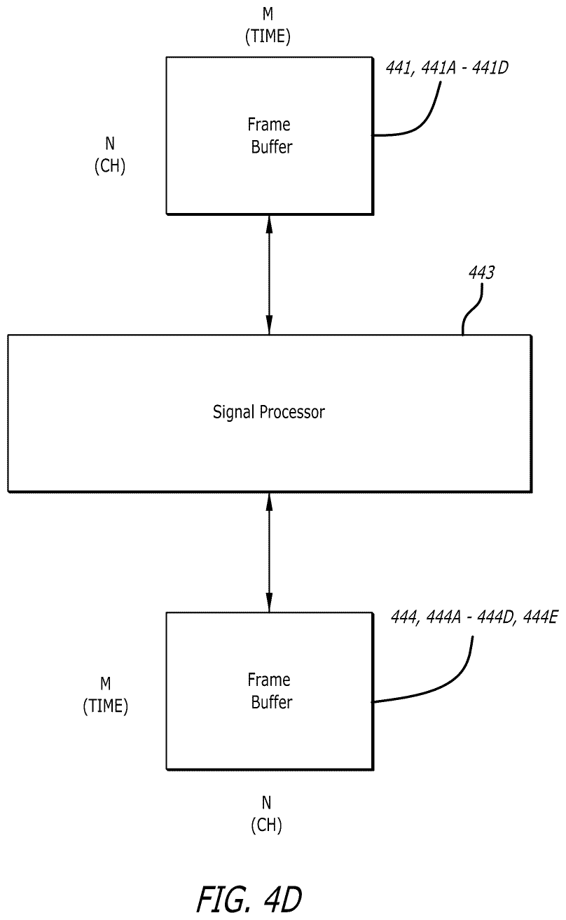

Referring now to FIGS. 4A-4C, a first image capture process by an electro-optic imaging system for a flow cytometer system or cell sorter system is shown. The system includes a linear array detector 414 to capture images of a moving cell (or flowing cell) 404 within sample fluid 406 and flow channel of a transparent cuvette 400. The flow rate of cells 404 in the sample fluid 406 in the flow channel of the transparent cuvette 400 of a flow cell can vary. Typically, the flow speed or flow rate V0 of cells ranges from one tenth (0.1) to five (5.0) meters per second (m/s). As the sample fluid 406 flows, it is desirable to continuously capture images of each cell 404 with the linear array detector 414 as they flow by an interrogation region in the flow channel of the transparent cuvette.

As the cell 404 flows into the interrogation region of the transparent cuvette 400 of the flow cell, a magnified cell image 410 is generated by an optical imaging system 408. Portions of the magnified cell image 410 can be captured over a plurality of adjacent time periods ti-tx (e.g., t5-t10) through a linear slot or slit in a mask or linear aperture device 412 by the linear array detection subsystem 494, including a linear array detector 414. The magnified cell image 410 moves across the slit of the linear aperture device 412 and the linear array detector 414 at a rate of the flow speed of the moving cell times the amount of magnification.

Referring momentarily to FIGS. 10A-10B a top view and side view of a linear mask or linear aperture device 412 over the linear array detector 414 are respectively shown. The linear mask or linear aperture device 412 has a linear slit or slot 413 that allows a line of light to pass through onto the photodetectors 415 in the linear array detector 414. An optional optical color filter 1011, a bandpass light filter (bandpass optical filter), can be aligned with and positioned over the linear aperture device 412 and position over the linear slit or slot 413 so as to filter out (by absorption or reflection) one or more ranges of wavelengths of light from reaching the photodetectors 415 in the linear array detector 414 so that a desired range of wavelengths (pass band) of light passes through the slot and is detected by the linear array detector 414. The bandpass light filter 1011 over the linear slot of the mask can be used to selectively choose a wavelength bandwidth range to pass (pass band) through into the linear slot and onto the plurality of photodetectors in the linear array detector 414.

The dimensions of the linear slit or slot 413 assures the height of the image portions of the cell image are normalized to the height of each individual photodetector 415 in the linear array detector 414. The height of the linear slit or slot 413 is also associated with the speed of data capture and the flow rate of cells in the sample fluid. The overall width of the image portion of the image is set by the width of each individual photodetector and the number of the plurality of photodetectors (e.g., 16, 32) in the array. The width of the linear slit or slot 413 is set to be greater than or equal to the overall width. The overall width of the linear array detector is related to the largest moving biological cell or particle that is desired to be detected in the sample fluid.

The linear array detector 414 forms a line scan camera with the plurality of photodetectors 415 (e.g., PD1-PD16) arranged or aligned in a row to form a linear array of detectors. In one embodiment, there are sixteen (16) image sensors (e.g., photodetectors) aligned in a row of the linear array detector 414. Each photodetector (image sensor) 415 in the linear array detector 414 can be an avalanche photo diode (APD) to enhance signal gain. As shown in FIG. 10B, the linear array detector 414 captures an image slice or line 1013 of the cell image 410 or magnified cell image in a single clock cycle of a digital clock signal or a time period. As the moving biological cell moves along the flow cell/cuvette, different image slices or image lines are the cell image 410 are captured in different clock cycles or time periods.

Each image sensor (photodetector) in the linear array detector forms a detector channel. The analog signal output is read out in parallel from each image sensor for each pixel and further processed in parallel by parallel adjustable gain amplifiers, and parallel analog to digital (AD) converters (ADC). The parallel adjustable gain amplifiers can independently selectively increase the amplitude of each of the analog signals. The parallel analog to digital converters (ADC) transduce the amplified analog signals into digital signals for each detector channel.

An example of a linear array detector is a silicon avalanche photodiode array, model S15249 made by Hamamatsu Photonics KK. This silicon avalanche photodiode array has a row of 16 image sensors (spectral wavelength range between 350 nm to 1000 nm) each having a photosensitive area forming a pixel with a pixel width of 0.7 mm, a pixel height of 2.0 mm, and a pixel pitch of 0.76 mm. Another example of a linear array detector is a silicon avalanche photodiode array model S15609 made by Hamamatsu Photonics KK having an array of 16 image sensors (spectral wavelength range between 400 nm to 1200 nm) with a pixel width of 0.43 mm and a pixel height of 0.15 mm forming a pixel pitch of 0.5 mm. Another example of a linear array detector is a silicon photodiode array model S4111-16Q made by Hamamatsu Photonics KK having an array of 16 image sensors (spectral range from ultraviolet to near infrared light) with a pixel width of 0.9 mm and a pixel height of 1.45 mm forming a pixel pitch of 1.0 mm. The linear array detectors include integrated support circuitry and are packaged as single package devices with pins as a connector or a single printed circuit board with an edge connector, pins, or solder pads as the connector.

Referring back to FIGS. 4A-4C, the linear array detection subsystem 494, includes the linear array detector 414, a multi-channel amplifier 416, and a multi-channel analog to digital converter (ADC) 418 that can be integrated together as a custom integrated circuit or by using off the shelf parts mounted on a printed circuit board and coupled in communication together. The parallel analog outputs of the image sensors (photodetectors) in the linear array detector 414 operating in parallel are coupled to the parallel inputs of the multi-channel amplifier 416 having a plurality of low noise gain amplifiers operating in parallel, one for each image sensor (photodetector). The analog signals from the parallel analog outputs of the linear array detector are each amplified by respective low noise amplifiers in the multi-channel amplifier 416.

The outputs of the low noise amplifiers in the multi-channel amplifier 416 are coupled to the parallel analog inputs of the multi-channel analog to digital converter (ADC) 418. The multi-channel analog to digital converter (ADC) 418 has a plurality of ADCs in parallel, one ADC for each channel to convert an amplified analog signal into a digital signal. The resolution of each ADC can be 12 bits or more. The sampling rates of each analog to digital converter (ADC) and the rate of capture by the linear array detector are selected to meet the flow rate of cells in the flow cell/cuvette for a size of cells that are desired to be captured, and the magnification desired of the moving cells. The highest imaging speed of the linear array detection subsystem 494 is parallel analog outputs from the linear array detector with parallel amplifiers and parallel ADCs for each channel.

Referring now to FIG. 4B, as the magnified cell image 410 moves over the linear array detector, a chart 420 represents real time plots of amplified analog signals 421-436 for each increasing channel number (e.g., Ch1-Ch16) of a channel axis 438 along the Y axis over the time periods 440 along the X axis. The amplified analog signals are digitized by the multi-channel analog to digital converter (ADC) 418 into digital numbers as pixel data and stored in storage device such as a frame buffer memory 441. The digitized analog signals (digital numeric signals) represent slices of the cell image (image slices or image portions) in each channel over time (t₀ to tₓ). In a digital form, the pixel data for each slice of the magnified cell image 410 can be stored in an N by M frame buffer memory 441 commonly used in computer graphics controllers.

The plot of analog signals over time does not represent an image of a cell that a user can view and understand. Nor does the digital conversion of analog signals into digital numeric signals of pixel data represent a cell image a user can view and understand. The cell image 410 that a user can view and understand is reconstructed from the digitized analog signals in order to more properly represent the plurality of image slices over time. Moreover, cellular image artificial intelligence (AI image analysis) software that a processor can use to analyze a cell image prefers to have the cell image properly reconstructed to better match its training with known images of cells.

Referring now to FIGS. 4B-4D, the digital data from the ADCs representing the pixels captured by each image sensor can be stored in storage device such as a first N by M frame buffer memory (frame buffer) 441. Once the digital signals of the cell image 410 are captured for each image portion for each time period, digital signal processing by a signal processor 443 or the like (e.g., image reconstruction logic) can be used to rearrange the data into a second M by N frame buffer memory (frame buffer) 444 to form the reconstructed cell image 410′.

In FIG. 4C, software, hardware (signal processor, memory, storage), firmware, or combinations thereof 442 can be used to provide the algorithms executed by a processor 443 or other digital logic (e.g., reconstruction logic) to reconstruct the digital data (digital numeric data) of the plurality of image slices over time into a whole image of a reconstructed cell image 410′. The digital data represents pixels where portion of the image of the cell are captured. Generally, for image reconstruction of the reconstructed cell image 410′, a matrix transpose operation is used. A matrix of digital values representing pixels of each channel (y axis) over time (time periods—x axis) stored in a frame buffer 441 is transposed into a matrix of each time period 440 (y axis) over each channel of the channel axis 438 stored in a frame buffer 444. Two or more frame buffers can be used (see FIG. 4D) so while one buffer is being filled with new data, the second frame buffer holds transposed data that can be analyzed. A single frame buffer can also be used while some other storage device holds a matrix of the transpose.

FIG. 4D is a block diagram of a processor 443 interfacing with two or more sets of frame buffers 441,441A-441D; 444,444A-444D, 44E) to transpose and process pixel data. The signal processor 443 and the image reconstruction algorithm (logic) are coupled in communication with the two or more sets of frame buffers, or a single frame buffer and another storage device, to access the digital numeric signals representing each pixel in each brightfield image line. This is so the signal processor 443 and the image reconstruction algorithm (logic) can reconstruct the brightfield image lines of each cell over time periods into a single overall brightfield image of each cell that can be processed by AI, recognized, and categorized to make sorting decisions or further cell analysis. The single overall brightfield image can be stored with the cellular event (fluorescence, side scatter data over a time period of the presence of a cell in the interrogation region) and presented to a user for viewing as well.

With reference to both FIGS. 4C and 4D, from a first (input) frame buffer 441 to a second (output) frame buffer 444, the pixel data is transposed from channel (along the channel axis 438) versus time (along the time axis 440) to time (along the time axis 440) versus channel (along the channel axis 438). A reconstructed cell image 410′ of a cell can be generated in the second frame buffer 444 by a signal processor 443 using the image reconstruction algorithm. The events, detection of portions of a cell by an image sensor, are justified in time by the signal processor 443. The signal processor can also spatially adjust the position of the reconstructed image (moving the channel pixel data up or down) so that the cell image is more centered in the matrix of pixel data.

Events started by a boundary of a cell can be identified by the forward scattered detector generating a trigger signal. The linear array detector and the analog to digital converter can be constantly clocked while a complete sample with all cells are run through and continuously generate pixel data. They can also be selectively gated by the trigger signal in another case when data is desired to be saved. A forward scattered detector can detect the boundaries of the cell selectively generating the trigger signal when a cell is present and killing the trigger cell when a cell is not present. The trigger signal can identify the overall event of a cell by its boundaries. If after calibration to zero any pixel is a non-zero digital value, then a start boundary of a cell is identified and the trigger signal generated. A start time period ts may be the same or one or more time periods before the boundary is identified and trigger signal generated. When all pixels return to zero digital values, the end boundary of a cell is identified, and the trigger signal is killed. An end time period te may be the same or one or more time periods after the end boundary of a cell is identified. With start and end time periods, the number of time periods in the event that are captured by the linear array detector is known and an event with the digital data detecting a cell can be assembled together. Generally, the number of time periods is associated with the height of the cell that flows by the interrogation region for a given flow velocity and clock sample rate. A digital clock can be used to generate the times of each sample time period in order to synchronize data as it is sampled. Each digital data for an image line can be associated with a time stamp of the digital clock, referenced to a trigger signal time stamp, and an event number associated with a cell. The digital data can be packetized into a packet for each event and sent to a computer for further analysis and used locally for sorting decisions in real time.

A laser or other kind of illumination light 402 from a light source 401 with wavelengths of light around a center wavelength, is focused into an examination (interrogation) region of the transparent cuvette of the flow cell to illuminate the cells 404 in the sample fluid 406 flowing into the examination region. The illumination light provides a back light for each biological cell or particle in the sample fluid. This can be brightfield imaging of the cell but could also be fluorescent imaging as well using the appropriate laser with a wavelength that causes fluorochromes attached to a cell to fluoresce. A laser profile of the cell (back lit light forming a shadow) is magnified by the optics in the optical imaging system 408 to match that of the sensor size of the linear array detector. In one embodiment, the laser light source 401 is a blue laser and the illumination light is a laser light 402. The laser light 402 scans through the cell as it passes through the interrogation region in the flow cell.

The desired X axis field of view of the laser illumination in the interrogation region across the sample flow in the transparent cuvette 400 of the flow cell is a function of the total sensor length of the linear array detector divided by the optical magnification rate provided by the optical imaging system 408. The Y axis field of view of the laser illumination in the interrogation region can be unlimited. For example, assume a total sensor length of twenty-five (25) millimeters and a magnification rate of five hundred times (500×). The X axis field of view is then fifty (50) microns.

The X axis spatial resolution of the linear array detector is a function of the sensor pitch of the image sensor in the linear array detector divided by the optical magnification rate provided by the optical imaging system 408. For example, assume a sensor pitch of two-hundred-fifty (250) microns per pixel and a magnification rate of five hundred times (500×). The X axis spatial resolution is then two-hundred-fifty (250) microns per pixel divided by five hundred (500) which is equal to 0.5 microns per pixel or 0.2 to 1 line pair per micron (lp/um).

The Y axis spatial resolution is comprised by two factors: the static imaging resolution and the resolution degradation by the moving object. To get better static imaging resolution, an aperture device with a slit or slot can be used to limit pixel height. If a one half millimeter (0.5 mm) slit height is chosen and the optical imaging magnification rate is 500×, the equivalent height of an image area in the object plane can be computed by the slit height (0.5 mm) divided by the magnification rate (500) which equals one micron (1 um). The second part is a function of the flow speed divided by the sampling rate. For example, the accumulation time of a pixel is 0.1 us if the sampling rate is 10 megahertz. Assume flow speed (rate) of 5 meters per second. In this case, the spatial resolution for a zero-width slit would be 0.5 um. Accordingly, given a linear aperture device 412 with a slit height of 0.5 mm, the combined Y-resolution would be equivalent to 1.5 um, or a range of about 0.1 to 0.3 line pairs per micron (lp/um).

In some embodiments, the field of view of the laser illumination in the interrogation region of the transparent cuvette 400 in the flow cell is desired to be around sixteen (16) microns wide by five (5) microns high to back illuminate the moving cells 404 that flow by. The linear array detector 414 has sixteen (16) image sensor (detector) elements or channels having a pitch of 0.76 mm with each detector element having a size of 0.7 mm by 2.0 mm. The image detectors in the linear array detector are desirous of having a high frequency, in one embodiment having a cutoff frequency of 100 megahertz (MHz). Accordingly, the analog to digital to converters in the multichannel ADC 418 are capable of switching at high frequencies as well, to quickly capture signals from the image sensors in the linear array detector.

Assume an image sensor has 0.5 um/pixel resolution in the Y-axis. A 16-micron wide laser profile is magnified to a 0.76 micron high by 16 mm wide sensor. The 16 um is spread over 16 elements for a resolution of 1 micron per pixel resolution in the X-axis. The horizontal resolution is based on the width of the interrogation region in the flow cell/cuvette and the width of the laser spread that can be achieved with optics. The horizontal resolution is 16 um over 16 elements that leads to 1 μm per pixel in the X-axis.

The vertical resolution on Y axis of the linear array detector depends on the flow speed and the sampling rate. Assume 3.8 meters per second flow speed for cells in the flow cell. A sixteen multi-channel DAC can be clocked up to 80 Mhz but need only the Nyquist rate of 7.6 Mhz. The signal from each pixel will be recorded at high sampling rate (>3.8 MHz for 3.8 m/s flow). Then the captured digital data from each pixel over time is used to reconstruct the image. The vertical resolution in the Y-axis is a time resolved readout and is determined by the sampling rate. For example, if the sampling rate is 1.9 MHz then the vertical resolution is 1 sample/2 um. If the sampling rate is 3.8 MHz, then the vertical resolution is one sample per micron (um). If the sampling rate is 7.6 MHz, then the vertical resolution is two samples/um. If the sampling rate is 15.2 MHz, then the vertical resolution is four samples/um in the Y-axis.

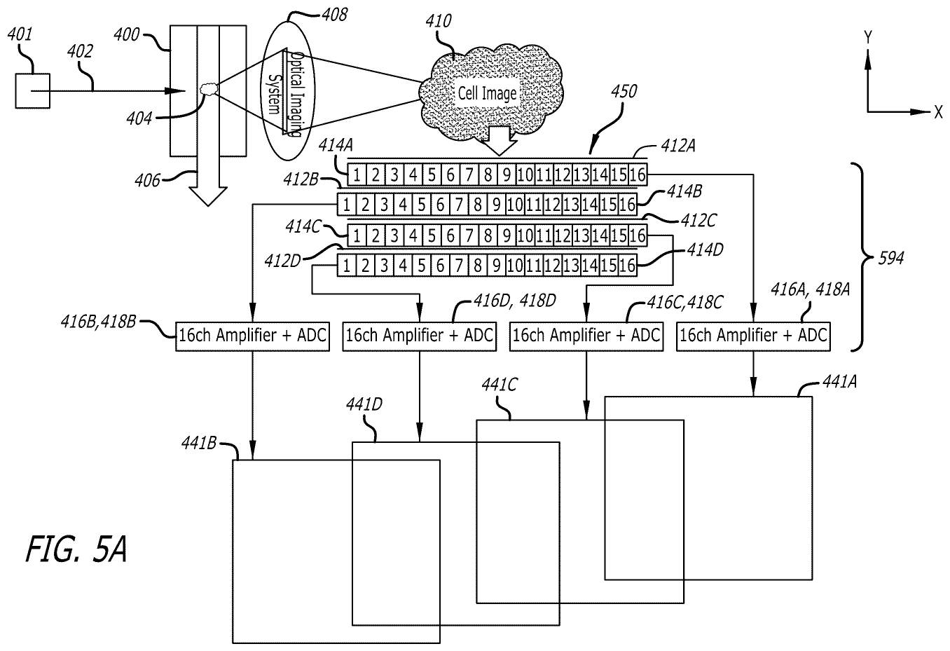

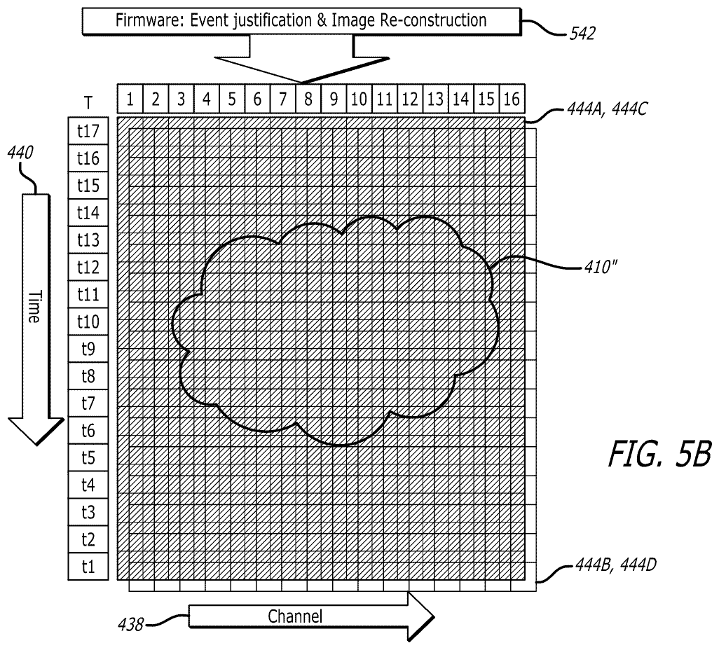

Referring now to FIGS. 5A-5B, a sensor array 450 including a plurality of linear array detectors 414A-414D and associated aperture devices 412A-412D can be used to capture image slices of a moving cell image 410 for each of the moving cells in the flowing biological sample fluid 406. The plurality of linear array detectors 414A-414D are carefully arranged on the image plane to provide interleaved sampling so as to increase the spatial resolution and improve the signal to noise ration of the reconstructed cell image. FIG. 5A illustrates four linear array detectors, each with 16 channels, so that there are 4×16 channels total in this case capturing pixel data. The plurality of linear array detectors 414A-414D can be formed on the same silicon substrate in a single integrated circuit. Interleaving between pixels in the X and/or Y axes can be used to improve pixel data between linear array detectors. Redundant sampling can be used to improve pixel data as well. With the arrangement of the linear array detectors 414A-414D shown in FIG. 5A, there is a doubling of spatial resolution and signal to noise (S/N) ratio over a single linear array detector shown in FIG. 4A.

In a Y axis, the plurality of linear array detectors 414A-414D can be slightly spatially offset or staggered from nearest neighbors so that there is a slight temporal offset such that different data is captured by each linear array detector with a given clock signal and time period. Interleaved sampling on the Y-axis is achieved by carefully arranging the Y-spacing (pitch) between detectors, to make an offset on the sampling time window between the detectors. In FIG. 5A-5B, the offset can be half of the sampling window set by a sample clock.

Pairs of linear array detectors can be aligned together with redundant pixel data being fused together to have better information for each pixel. Two detectors can be arranged to have the same X-position with pixel data being captured by a synchronized sampling window. In FIG. 5A, the odd linear array detectors 414A,414C are spatially aligned together along an X-axis. On adjacent odd clock timer period (e.g., t3 and t5), similar odd pixel data can be captured by the odd linear array detectors 414A,414C but offset in time from each other. The similar odd pixel data can be captured, added together, and averaged out to temporally improve signal to noise ratio. The even linear array detectors 414B,414D are spatially aligned together along the X-axis. On adjacent even clock time periods (e.g., t1 and t3), similar even pixel data can be captured by the even linear array detectors 414B,414D but offset in time from each other. The similar even pixel data can be captured, added together, and averaged out to temporally improve signal to noise ratio.

Interleaved sampling can be achieved on the X-axis as well by shifting additional linear array detectors along the X-axis. In FIG. 5A, the odd linear array detectors 414A,414C can be spatially offset (slight left or right such as by fraction of a pixel width—one half pixel width for example) from the even linear array detectors 414B,414D. Digital data values for the nearest neighbor pixels in the linear array detectors 414A-414D can be used to improve signal to noise ratio in the formation of the reconstructed cell image 410″. The pixel data from a channel of an odd linear array detector and the pixel data from the same channel of the even linear array detector can be interleaved by summing values together and averaging them out to improve signal to noise ratio spatially on the same clock period of each clock period. For example, pixel data from channel one of the odd linear array detector 414A can interleaved with the pixel data from channel one of the even linear array detector 414B on time period three to spatially improve signal to noise ratio in the formation of the reconstructed cell image 410″.

Besides interleaving, other video graphic controller techniques for pixels can be used, such as dithering, to interpolate digital data for a pixel over the multiple digital numeric signals and improve signal to noise ratios in the formation of the reconstructed cell image 410″.

The linear masks or apertures 412A-412D over the respective linear array detectors 414A-414D with the linear slot can include an optical color filter to filter out different colors so each can receive a different color such as red, green, blue, yellow for example, instead of a just a single color. Other color filters can be selected from the spectrum to receive a different color or a different spectrum such as ultraviolet for example. The pixel data for the different colors may be used to extract features or boundaries that may be better seen with a different color.

In operation, the cell 404 flows down the transparent cuvette 400 of the flow cell, is lighted by the laser light 402 in the interrogation region and magnified by the optical imaging system 408 to form the moving cell image 410. The moving cell image 410 moves across all aperture devices 412A-412D having slits and the associated linear array detectors 414A-414D and the array of image sensors in the channels of each. A plurality of multichannel amplifiers 416A-416D are respectively coupled to the plurality of linear array detectors 414A-414D. A plurality of multichannel analog to digital converters (ADC) 418A-418D are respectively coupled to the plurality of multichannel amplifiers 416A-416D to receive amplified analog signals and convert them into digital signals representative of the pixel information captured by the image sensor. A plurality of initial image frame buffers (memory) 420A-420D are coupled in communication with the plurality of multichannel analog to digital converters (ADC) 418A-418D to store the initial image data representing image slices over time prior to signal processing.

In FIG. 5B, software, hardware (signal processor/controller, memory, storage), firmware, or combinations thereof 542 can be used to execute algorithms in firmware to reconstruct the digital data of the plurality of image slices from the plurality of linear array detectors over time into a whole reconstructed cell image 410″ of a cell. The digital data represents pixels where portions of the image of the cell are captured. From the plurality of initial frame buffers 441A-441D interleaving can be used to form a second frame buffer 444, the pixel data is transposed from channel (along the channel axis 438) versus time (along the time axis 440) to time (along the time axis 440) versus channel (along the channel axis 438)

Referring to FIG. 4D, the reconstructed cell image 410″ can be generated by a signal processor 443 in the second frame buffer 444 using an image reconstruction algorithm with the interleaving of pixel data. For each linear detector of the plurality, an event is marked with a starting time period when a first portion (boundary) of a cell is detected by any image detector in any of the plurality of linear array detectors. The end of the event is marked with an ending time period when no parts of a cell are detected by any detector in the plurality of linear array detectors—generally indicated by substantially zero data from each pixel after being calibrated. All of the image lines over the time periods of capturing non-zero data are associated with the event. After the complete event is captured with all of the plurality of linear array detectors, the signal processor 443 can perform data transposition from a first set of (input) frame buffers 441A-441D with N by M data into a second set of (output) frame buffers 444A-444D with M by N data. Various types of interleaving can then be used to form pixel data into another M by N frame buffer 444E holding the reconstructed image 410″ for subsequent processing.

### Image Capture and Cell Sorting

An image of a moving biological cell (cell image) is captured by a linear array detector. The cell image can be used to provide cell sorting information to sort the different cells that can be found in a biological sample. The linear array detector is lower in costs than full image camera devices. With parallel output and support circuitry, the linear array detector can capture an image of a moving cell at ultrahigh speed so that a decision can be made to sort out cells into different drop streams captured by different test tubes or different wells in a well plate. Accordingly, a linear array detector can be used to form a lower cost cell sorter.

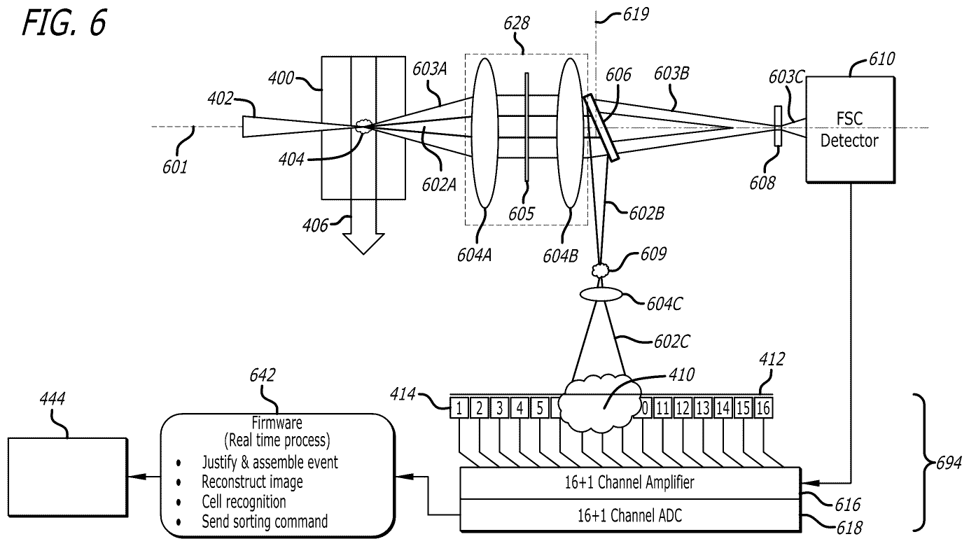

Referring now to FIG. 6, a cell sorting system 600 is shown that uses bright field imaging of moving cells to perform cell sorting. The cell sorting system 600 includes a linear array detector 414 with N channels of photodetectors that are used to capture image slices of the magnified bright field cell image 410. A forward scatter detector 610 is used to capture a focused forward scattered (FS) light signal 603B and generate a trigger signal indicating a beginning boundary of a cell. The focused forward scatter light signal 603B can be used to trigger the multichannel amplifier 616 and the multichannel analog to digital converter 618 to respectively amplify the analog signals, convert them into digital signals, and capture them with a storage device, such as a buffer memory in the ADC, based on the trigger signal. The forward scatter detector 610 can detect a loss of the focused forward scattered (FS) light signal 603B indicating an end of the boundary of a cell. The detection of the loss of the focused forward scattered (FS) light signal 603B stops generation of the trigger signal and ends amplification of the analog signals, the conversion of the analog signals into digital signals, and the capture of the digital signals with the storage device.

A circular cylinder of laser light 402 when striking a moving cell 404 in the flow of sample fluid 406 in the interrogation region of the transparent cuvette 400 of the flow cell, forms a diverging bright field light signal 602A with potential light rays in the shape of a truncated circular cone and a diverging forward scattered light signal 603A with potential light rays in the shape of a truncated circular hollow cone along a first optical axis 601. Objective optical elements (optical subsystem) 628 receive the bright field light signal 602A and the forward scattered light signal 603A. In one embodiment, the objective optical elements 628 include a first lens 604A, a filter 605, and a second lens 604B spaced apart from each other. The first lens collimates the bright field light signal 602A and the forward scattered light signal 603A. The optical filter 605 filters out undesirable wavelengths of light and allows light of the desired wavelengths to pass. In FIG. 6, the wavelength of the laser light 402 used to form a bright field image of the cell (as well as the forward scattered light) is allowed to pass. The second lens 604B receives the collimated light and focuses the forward scatter light signal 603B down to the circular opening in the aperture device 608 and focuses the bright field image signal 602B down to the focal point 609.

Objective optical elements 628 receive the bright field light signal 602A and focus it into a focal image point 609 via the mirror central, central mirror, or center mirror 606. The mirror 606 is a flat mirror and angled (e.g., forty-five degrees) with respect to the first optical axis to redirect the bright field light signal 602A from the first optical axis at about ninety degrees into a bright field image signal 602B along a second optical axis 619 that is perpendicular to the first optical axis 601. In an alternate embodiment, a flat mirror with a center opening can aligned with the optical axis. In this case, the flat mirror is configured to reflect forward scattered light to a forward scatter detector and allows light representing the brightfield image of the cell to pass through the center opening to the linear array detector.

The objective optical elements 628 causes the bright field image signal 602B to converge to a focal point 609 where an image of the moving cell is formed. At the focal point 609, the cell image by objective lenses is only about 5× and not large enough to spread over a sufficient number of detectors in the linear array detector 414. A field lens 604C along the optical axis 619, acting as a relay imaging lens, receives the diverging bright field image signal 602B just past the focal point 609, and forms the bright field signal 602C in order to magnify the cell image by objective into the magnified bright field cell image 410 that is scanned over the linear aperture device 412 and the linear array detector 414. The field lens 604C provides about ten times (10×) magnification so that the magnified bright field cell image 410 of the cell is about 500× or five-hundred times the actual size of the cell 404. The field lens 604C better matches the image size of the cell to the linear array detector.

The linear aperture device 412 has a linear slot to allow a line of the magnified cell image to be imaged onto the linear array detector 414 through the slot. The linear array detector 414 has N channels with N photodetectors. A multichannel amplifier 616 is coupled to and between the linear array detector 414 and a multichannel ADC 618. The multichannel amplifier 616 has N+1 analog gain amplifiers to amplify the analog output signal from each of the N photodetectors and the analog output signal from the forward scatter detector 610. The N+1 amplified signals are coupled into the N+1 analog inputs of N+1 analog to digital converters of the multichannel ADC 618. The extra channel in the multichannel amplifier 616 and the multichannel ADC 618 is for the forward scatter detector to determine a zero digital value and a non-zero digital value for the selective generation (beginning and end) of a trigger signal. The multichannel ADC 618 converts the N+1 analog signal inputs into N+1 digital outputs. Each analog to digital converter may be m-bits wide generating an m-bit digital signal (e.g., 8, 12, or 16 bits) to accurately represent the analog signal for each pixel in the channel or row of the linear array detector 414. The multichannel ADC 618 includes a line buffer memory to temporarily store each line of the magnified image and the value of the forward scatter light that is detected. Over clocked time periods, each line of digital data from a line buffer in each ADC can be moved into a frame buffer 441. The storage device for the frame buffer is sufficiently large to store the largest expected cell size. Based on the trigger signal, the number of time periods and image lines are known for a given cell which may be a subset of the size of the storage device. If exceeded, the signal processor 443 can find other storage to use for a frame of data associated with an event.

Objective optical elements 628 receives the forward scattered light signal 603A and focuses it as focused forward scattered light signal 603B converging into a focal point in the circular opening of a circular aperture device 608. After the circular aperture device 608, the focused forward scattered light signal 603B diverges somewhat into the forward scattered light signal 603C that can be captured by a forward scattered light detector 610, such as a photodetector or photo diode.

The forward scattered signal 603B detected by the forward scattered light detector 610 can be used to start amplification by the amplifier 616 and start data conversion and data capture by the multichannel ADC 618. When the forward scattered signal 603B is no longer detected by the forward scattered light detector 610, the amplification, data conversion and data capture can all be ended until the next moving cell flows into the interrogation region of the transparent cuvette 400 of the flow cell and the initial forward scattered light signal is detected once again.

The local controller or signal processor 443 or other custom circuits can be configured to execute firmware instructions 642 stored in firmware memory in real time in order to process the pixel data of the image slices stored in the frame buffer 441. The digital data in the frame buffer is justified and assembled into an event associated with the interrogation of a moving biological cell in the flow cell. The data in the frame buffer is then used to reconstruct the image of each cell into the framed buffer 444. The instructions in the firmware further cause the biological cell to be recognized by an imaging analysis process. Based on the recognized cell type, a sorting command can be selectively generated that can alter a voltage on the charge plates. This allows a charged drop including the biological cell to be binned out (left or right or center) into one of a plurality of different test tubes or one of a plurality of different wells in a well plate or alternatively, remain in a center axis line to be discarded.

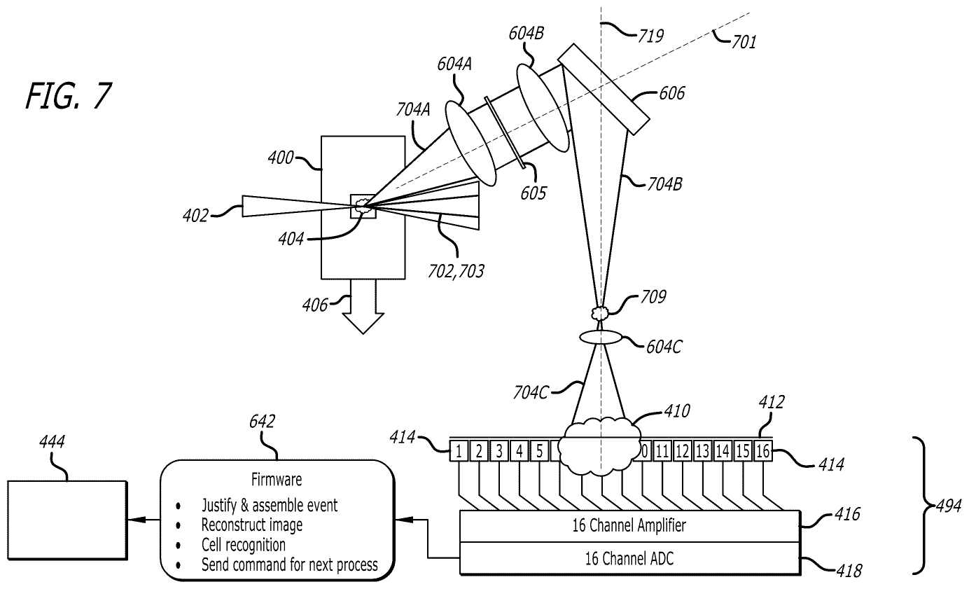

FIG. 7 illustrates a view of an electro-optical system to capture images of the moving cell from a fluorescence light signal or a side scattered light signal 704A. The channel of fluorescence light signal and side scattered light signal 704A is not aligned with the optical axis of the laser and forward scatter light signal 702, 703. When no cell present in the interrogation region of the transparent cuvette 400 of the flow cell, a laser signal 702 is captured as normal by a forward scatter detector. When a moving cell is in the interrogation region, the forward scattered light signal 703 is captured as normal by a forward scatter detector to start or mark the capture of images slices by the linear array detection subsystem 494.

The fluorescence light signal and/or the side scatter light signal 704A is received by the first lens 604A and collimated towards a light filter 605 and a second lens 604B. The band pass of the optical filter 605 is selected so that it filters out undesirable wavelengths of light (by absorption or reflection) and allows light of the desired wavelengths (pass band range of wavelengths) to pass. In this case, the wavelengths of selected fluorescent light and/or side scattered light is desirable and allowed to pass through the optical filter 605. The second lens 604B focuses the fluorescence light signal and/or the side scatter light signal 704A to a focal point 709. Before reaching the focal point 709, the fluorescence light signal and/or the side scatter light signal 704A along the optical axis 701 is reflected by a flat mirror 606 along an optical axis 719 as a reflected fluorescence light signal and/or the side scatter light signal 704B.

At the focal point 709, an image of the moving cell 404 is formed by the convergence of the fluorescence light signal and/or the side scatter light signal. After the focal point 709, the fluorescence light signal and/or the side scatter light signal diverges into a third lens 604C, a field lens, that magnifies the image of the cell into a magnified image 410 at the linear aperture device 412 with the linear slit. Over clock periods (time periods) of a clock started by the forward scattered signal, image slices of the magnified image 410 are captured by the linear array detection subsystem 494, including the linear array detector 414, the multi-channel amplifier 416, and the multichannel ADC 418.

The captured images slices are saved in a frame buffer 441 for the signal processor to execute firmware instructions 642 and reconstruct an image of the moving cell 404 into the frame buffer 444. The firmware instructions 642 that are executed further justify and assemble the image slices into an event, representing the detection of a moving cell. The firmware instructions 642 that are executed further perform cell recognition from the reconstructed image and send a command for the next process in the flow cytometer/cell sorter based on the cell recognition.

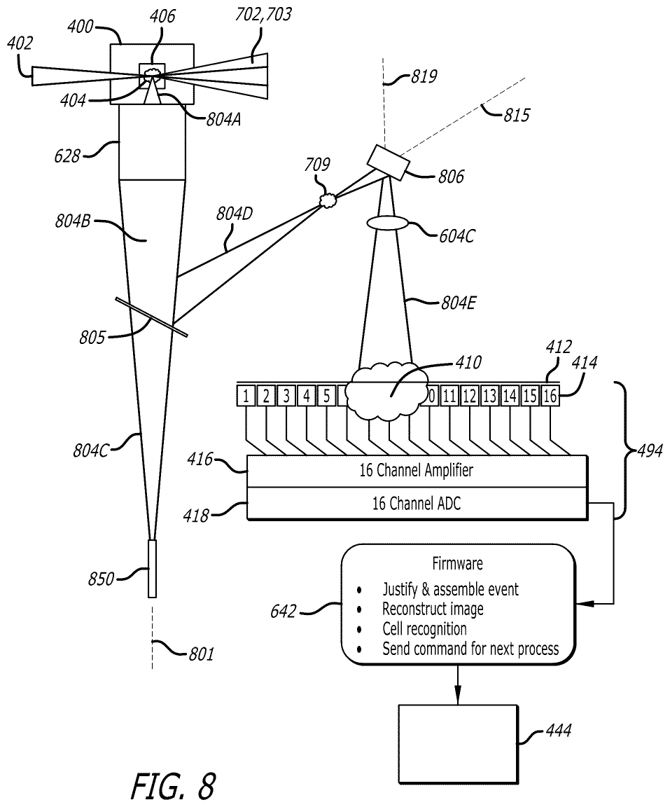

Referring now to FIG. 8, a top view of another electro-optical system is shown to capture images of the moving cell 404 from a fluorescence light signal or a side scattered light signal 804A. A laser light 402 is directed into the interrogation region of a transparent cuvette 400 of the flow cell. Accordingly, the cuvette is transparent to light and can be referred to as a transparent cuvette to receive laser light and allow fluorescence light and side scatter light to be emitted from the cuvette. Some of the laser light signal 702 is received by a forward scattered detector. The moving cell 404 in the flowing sample fluid makes its way into the interrogation region with the laser light signal 702 striking the moving cell thereby forming a fluorescence and/or side scattered light signal 804A. The objective optical elements 628 receive the fluorescence and/or side scattered light signal 804A magnify the image of the cell and focuses it as a focused fluorescence and/or side scattered light signal 804B down to an input end of one or more optical fibres 850 along an optical axis 801. In one case, the objective optical elements 628 provide ten times (10×) or ten times the magnification of the cell.

Along the optical axis 801, a beam splitter 805 at a first angle (e.g., 45 degrees) with the optical axis 801, selects a portion of the power (e.g., 20% power) in the light signal 804B for imaging and directs it at a complimentary angle (e.g., 45 degrees) to the first angle along an optical axis 815 forming a fluorescence and side scattered light signal 804D. The beam splitter 805 splits off a portion of the light signal 804B and redirects it along the optical axis 815 that is at a second angle with the optical axis 801 complimentary with the first angle. The beam splitter 805 can optionally be a notch filter (or include a notch filter) to select a wavelength range of light in the focused fluorescence and side scattered light signal 804B and redirect it into the optical axis 815 for imaging purposes.

After the beam splitter 805, the input end of one or more optical fibres 850 receives the remaining fluorescence and side scattered light signal 804C along the optical axis 801 and directs it to one or more detector modules including an array of eight or more photodetectors in the flow cytometer/cell sorter system. These one or more detector modules are respectively coupled to the output end of the one or more optical fibres 850 to receive the fluorescence and side scattered light signal 804C. These one or more detector modules are fluorescence detector arrays with fluorescence detectors and in some cases side scatter detectors. For example, the one or more detector arrays at the opposite end of the one or more optical fibres 850 are generally described in U.S. patent Ser. No. 11/029,243 titled COMPACT DETECTION MODULE FOR FLOW CYTOMETERS, issued on Jun. 8, 2021, to inventors Ming Yan et al., incorporated herein for all intents and purposes.

At a similar distance to the input of the one or more optical fibres 850 from the objective optical elements 628, a middle cell image of the cell is formed at a focal point 709 along the second optical axis 815 by the convergence of the selected wavelengths of the fluorescence and side scattered light signal 804D that was redirected by the beam splitter 805. The middle cell image at the focal point 709 has the same size as the cell size or is magnified, such as ten times (10×) of the cell size. From the focal point 709 where the middle cell image of the cell is formed, the fluorescence and side scattered light signal 804D diverges towards a flat or curved (concave or spherical) mirror 806 located on the second optical axis 815. The flat or curved mirror 806 is along the second optical axis 815 at a second angle (e.g., 45 degrees). The flat or curved mirror 806 redirects the fluorescence and side scattered light signal 804D at a second complimentary angle (e.g., 45 degrees) along a third optical axis 819 towards a field lens 604C, the linear aperture device 412, and the linear array detection subsystem 494. The third optical axis 815 is at the second complimentary angle to the second angle with the second optical axis 815. The optical axes 801,819 can be parallel in order to minimize the space utilized by the electro-optical system.

The field lens 604C magnifies the fluorescence and side scattered light signal 804D into a magnified fluorescence and side scattered light signal 804E forming the magnified image 410 of the moving cell at the input to the linear aperture device 412 and the linear array detection subsystem 494. For example, the field lens 604C can provide 50× magnification to spread the image over more photodetectors in the linear array detector 414.

As discussed previously, the linear aperture device 412 and the linear array detection subsystem 494 capture lines of digital pixel data representing image slices of the magnified image 410 of the moving cell over periods of time of a clock cycle. The image slices are captured in response to the presence of a trigger signal generated by generated by the forward scatter detector based on the forward scattered signal. The end or completion of image slice capture is based on the absence of the forward scattered signal and sensing of the laser signal across the interrogation region of the flow cell. A signal processor 443 executes firmware instructions 642 and can similarly process a frame buffer 441 of image slices into a frame buffer 444 of pixel data that reconstructs the cell image as discussed herein with reference to FIGS. 6A-6B. The signal processor 443 can further execute firmware instructions 642 that can recognize the type of cell in the cell image in order to make a sorting decision.

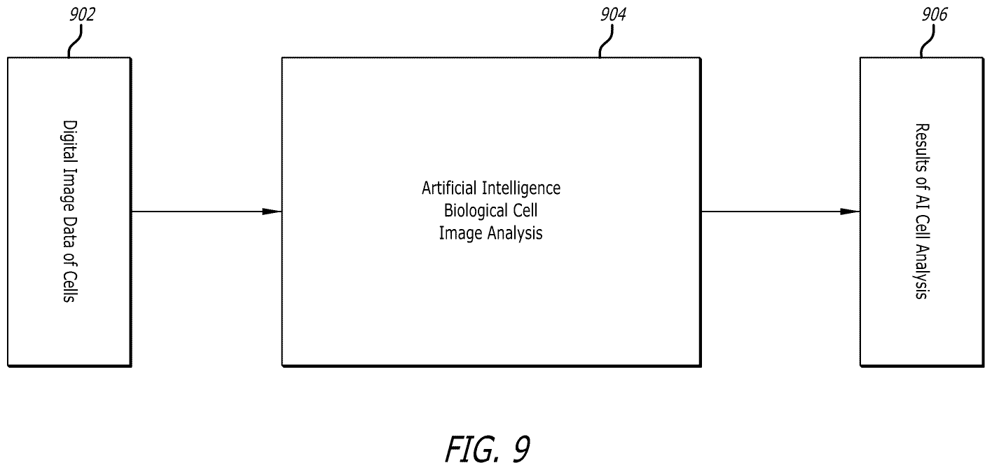

Referring now to FIG. 9, one or more frame buffers of digital pixel data 902 are input into a biological cell image analyzer 904 that uses an artificial intelligence (AI) model and algorithms to analyze the reconstructed images to recognize cells and the features of cells. The biological cell image analyzer 904 can be executed by a processor, such as the signal processor 443 shown in FIG. 4D.

The artificial intelligence model of the biological cell image analyzer 904 is trained using a data base of known biological cell images. The biological cell image analyzer 904 outputs a classifications related to cells and their probability results 906 based on the input of the digital pixel data 902 representing the reconstructed images. The probability results 906 provide accuracy percentages of the cell recognition/association with known classes of cellular images. The highest probability typically provides the best indication of the type of moving cell that was captured with the magnified cell image 410. For more details of an exemplary biological cell image analyzer 904, see for example U.S. patent Ser. No. 10/846,509 titled METHOD TO COMBINE BRIGHTFIELD AND FLUORESCENT CHANNELS FOR CELL IMAGE SEGMENTATION AND MORPHOLOGICAL ANALYSIS USING IMAGES OBTAINED FROM IMAGING FLOW CYTOMETER, issued to Li et al., which is incorporated herein for all intents and purposes.

### Advantages

There are a number of advantages to using linear array detectors in an imaging system of a flow cytometer to capture images of cells. Two significant advantages are high speed and high gain. The linear array detectors provide a parallel output to provide parallel channels, each with an amplifier and an analog to digital converter (ADC) connected to each photodetector in the linear array integrated circuit. The line rate for the linear array detector can easily reach tens of mega Hertz (MHz). The photodetectors in the linear array detector can be chosen from a variety types, with an avalanche photo diode (APD) being preferred because it provides superior performance and unbeatable high gain in comparison to other imaging devices (e.g., PIN photodiode) for each pixel. However, avalanche photo diodes tend to be more expensive and can require cooling for optimal performance.

The parallel output from the linear array detector allows image data in multiple channels to be processed in parallel to make it feasible to have continuous image capture and processing that is useful for high-speed cell sorting applications. For lower speeds (up to tens of kilo Hertz (kHz)) imaging, linear array detectors and associated circuits are lower in costs than high speed CMOS cameras that can capture similar data. A plurality of linear array detectors as a sensor array can be arranged to improve system performance and provide a better signal to noise ratio in the image, provide for automatic delay or flow speed calibration, and perhaps better Y or vertical resolution by using interleaving of the samples that are captured.

This disclosure contemplates other embodiments or purposes. It will be appreciated that the embodiments can be practiced by other means than that of the described embodiments, which are presented in this description for purposes of illustration and not of limitation. The specification and drawings are not intended to limit the scope of this patent document. It is noted that various equivalents for the particular embodiments discussed in this description may be practiced by the claimed invention as well. That is, while specific embodiments of the invention have been described, it is evident that many alternatives, modifications, permutations and variations will become apparent in light of the foregoing description. Accordingly, it is intended that the claimed invention embrace all such alternatives, modifications and variations as fall within the scope of the appended claims. The fact that a product, process, or method exhibits differences from one or more of the described exemplary embodiments does not mean that the product or process is outside the scope (literal scope and/or other legally recognized scope) of the following claims.

1. An electro-optic imaging system for a flow cytometer or cell sorter system, the electro-optic imaging system comprising:
a flow cell/cuvette through which a sheath fluid and a sample fluid with a plurality of biological cells aligned in a stream of a sample fluid;
a laser to generate a spectrum of light around a center wavelength coupled into one side of an interrogation region of a cuvette in the flow cell to provide a back light for each cell of the plurality of biological cells;
an optical subsystem on an opposite side of the interrogation region to receive a brightfield image of each cell of the plurality of biological cells formed by the back light and a forward scattered light;
a linear array detector having a plurality of detectors, the linear array detector to receive the brightfield image of each cell of the plurality of biological cells formed by the back light from the optical subsystem, the linear array detector to transduce light into analog signals representative of pixels in a plurality of brightfield image lines of each cell;
a plurality of low noise gain amplifiers respectively coupled to the plurality of detectors in the linear array detector;
a plurality of analog to digital converters respectively coupled to the plurality of detectors of the linear array detector to receive analog signals representative of each pixel in each brightfield image line, the plurality of analog to digital converters to transduce the analog signals into digital numeric signals for each pixel in each brightfield image line; and
image reconstruction logic coupled to the plurality of analog to digital converters to receive the digital numeric signals representing each pixel in each brightfield image line, the image reconstruction logic to reconstruct the plurality of brightfield image lines of each cell over time periods into a single overall brightfield image of each cell.

2. The electro-optic imaging system of claim 1, further comprising:
a mask over the linear array detector, the mask having a linear slot to allow a line of light to pass through onto the plurality of detectors in the linear array detector.

3. The electro-optic imaging system of claim 1, wherein:
the optical subsystem includes
a first lens to collimate the forward scattered light and the back light forming the brightfield image;
a second lens to focus the forward scattered light and the back light forming the brightfield image to a focal point; and
a third lens to magnify the back light and the brightfield image to spread the brightfield image over the plurality of detectors of the linear array detector.

4. The electro-optic imaging system of claim 1, further comprising:
a processor executing instructions of cellular image artificial intelligence software to recognize cells and features of cells in each single overall brightfield image of each cell.

5. The electro-optic imaging system of claim 1, further comprising:
a forward scatter detector to detect boundaries of each cell from the forward scattered light; and
wherein the optical subsystem includes a flat mirror with a center opening aligned with an optical axis, the flat mirror configured to reflect forward scattered light to the forward scatter detector and to allow light representing a brightfield image of a cell to pass through the center opening to the linear array detector.

6. The electro-optic imaging system of claim 1, further comprising:
a forward scatter detector aligned with an optical axis to detect boundaries of each cell from the forward scattered light; and
wherein the optical subsystem includes a central mirror to reflect light representing a brightfield image of each cell to the linear array detector and to allow forward scattered light to pass by the central mirror to the forward scatter detector.

7. The electro-optic imaging system of claim 5, further comprising:
a storage device in communication with the plurality of analog to digital converters to store digital signals representing each different image line of each cell; and
wherein the forward scatter detector captures a focused forward scattered (FS) light signal indicating a start of a boundary of each cell and generates a trigger signal; and
the trigger signal triggers the plurality of low noise gain amplifiers to amplify signals, the plurality of analog to digital converters to convert analog signals into digital signals, and the storage device to store the digital signals.

8. The electro-optic imaging system of claim 7, wherein:
the forward scatter detector detects a loss of the focused forward scattered (FS) light signal indicating an end of another boundary of each cell and stops generation of the trigger signal; and
the loss of the focused forward scattered light signal ends an amplification of signals by the plurality of low noise gain amplifiers, a conversion of analog signals by the plurality of analog to digital converters, and storage of digital signals by the storage device until a boundary of a next cell is detected.

9. The electro-optic imaging system of claim 6, further comprising:
a storage device in communication with the plurality of analog to digital converters to store digital signals representing each different image line of each cell; and wherein
the forward scatter detector captures a focused forward scattered (FS) light signal indicating a start of a boundary of each cell and generates a trigger signal, and
the trigger signal triggers the plurality of low noise gain amplifiers to amplify signals, the plurality of analog to digital converters to convert analog signals into digital signals, and the storage device to store the digital signals.

10. The electro-optic imaging system of claim 9, wherein:
the forward scatter detector detects a loss of the focused forward scattered (FS) light signal indicating an end of another boundary of each cell and stops generation of the trigger signal; and
an absence of the trigger signal ends an amplification of signals by the plurality of low noise gain amplifiers, a conversion of analog signals by the plurality of analog to digital converters, and storage of digital signals by the storage device until a boundary of a next cell is detected.

11. The electro-optic imaging system of claim 9, wherein:
wherein the image reconstruction logic includes one or more frame buffers coupled to a signal processor, wherein the signal processor executes instructions to reconstruct the plurality of brightfield image lines of each cell over time periods into a single overall brightfield image of each cell.

12-17. (canceled)

18. An electro-optic imaging system for a flow cytometer or cell sorter system, the electro-optic imaging system comprising:
a flow cell through which a sheath fluid and a sample fluid flow in a stream with a plurality of biological cells aligned in the stream of the sample fluid;
a laser to generate a spectrum of light coupled into one side of an interrogation region of a cuvette of the flow cell to provide a back light of each cell of the plurality of biological cells;
an optical subsystem on an opposite side of the interrogation region to receive a brightfield image of each cell of the plurality of biological cells formed by the back light and a forward scattered light;
a plurality of linear array detectors each having a plurality of detectors, each of the plurality of the linear array detectors to receive the brightfield image of each cell of the plurality of biological cells from the optical subsystem, wherein the plurality of linear array detectors are temporarily offset from each other generating different brightfield image lines for each time period, wherein odd linear array detectors are spatially offset by a fraction of a pixel from even linear array detectors, wherein each linear array detector to transduce light into analog signals representative of pixels in a plurality of brightfield image lines of each cell;
a plurality of multichannel low noise gain amplifiers respectively coupled to the plurality of linear array detectors;
a plurality of multichannel analog to digital converters respectively coupled to the plurality of multichannel low noise gain amplifiers to receive amplified analog signals representative of each pixel in each brightfield image line, the plurality of multichannel analog to digital converters to transduce the analog signals into digital numeric signals for each pixel in each brightfield image line captured by each of the plurality of linear array detectors;
a plurality of input frame buffers respectively coupled to the plurality of multichannel analog to digital converters to receive and store the digital numeric signals for each pixel in each brightfield image line captured by each of the plurality of linear array detectors over a plurality of time periods; and
image reconstruction logic coupled to the plurality of input frame buffers, the image reconstruction logic to access the digital numeric signals representing each pixel in each brightfield image line, the image reconstruction logic to reconstruct the plurality of brightfield image lines of each cell over time periods into a single overall brightfield image of each cell.

19. The electro-optic imaging system of claim 18, further comprising:
a plurality of masks respectively over the plurality of linear array detectors, each of the plurality of masks having a linear slot to allow a line of light to pass through onto the plurality of detectors in the plurality of linear array detectors.

20. The electro-optic imaging system of claim 18, wherein:
the image reconstruction logic includes a signal processor in communication with the plurality of input frame buffers, wherein the signal processor executes instructions to dither and interpolate over the digital numeric signals for each pixel in each brightfield image line in order to reconstruct the plurality of brightfield image lines of each cell over time periods into a single overall brightfield image of each cell.

21. An electro-optic imaging system for a flow cytometer or cell sorter system, the electro-optic imaging system comprising:
a flow cell with a sheath fluid and a sample fluid flowing with a plurality of moving biological cells forming a stream of a plurality of drops of sheath and sample fluid around the plurality of moving biological cells;
a transparent cuvette of the flow cell receiving the stream of the plurality of drops into an interrogation region;
at least one laser to generate at least one laser light beam coupled into one side of the interrogation region of the transparent cuvette to strike each cell of the plurality of moving biological cells;
an objective lens adjacent the flow cell and the transparent cuvette to receive a fluorescence light and side scatter light signal of each moving biological cell of the plurality of moving biological cells formed by the at least one laser light beam striking each moving biological cell, the objective lens focusing the fluorescence light and side scatter light signal to a focal point along a first optical axis;
a beam splitter before a point on a first angle with the first optical axis to receive the fluorescence light and side scatter light signal, split off a portion of the light signal and redirect it along a second optical axis at a complimentary angle to the first angle with respect to the first optical axis, a remaining portion of the light signal passing through the beam splitter towards the focal point;
an optical mirror centered on and at a second angle with the second optical axis, the optical mirror located on the second optical axis after an equivalent focal point from the objective lens, the optical mirror to receive a split off portion of the light signal and redirect it along a third optical axis at a complimentary angle to second angle;
a field lens centered along the third optical axis to receive the split off portion of the light signal and magnify it into a magnified fluorescence and side scatter light signal to form a magnified image of the moving biological cell at a magnification point; and
a linear array detector centered in alignment with the third optical axis at the magnification point to receive the magnified fluorescence and side scatter light signal, the linear array detector having a plurality of photodetectors to capture a line of the magnified image of each moving cell of the plurality of moving biological cells, the linear array detector to transduce light into a plurality of analog signals representative of pixels in a plurality of image lines of each cell;
a plurality of adjustable gain amplifiers respectively coupled to the plurality of detectors in the linear array detector, the plurality of adjustable gain amplifiers to amplify an amplitude of the plurality of analog signals; and
a plurality of analog to digital converters respectively coupled to the plurality of detectors of the linear array detector to receive the plurality of analog signals representative of each pixel in each image line, the plurality of analog to digital converters to transduce the plurality of analog signals into digital numeric signals for each pixel in each image line of the magnified image.

22. The electro-optic imaging system of claim 21, further comprising:
image reconstruction logic coupled to the plurality of analog to digital converters to receive the digital numeric signals representing each pixel in each image line, the image reconstruction logic to reconstruct the plurality of image lines for each cell over time periods into a single overall image of each moving cell.

23. The electro-optic imaging system of claim 21, further comprising:
a first end of an optical fibre near the focal point to receive the remaining portion of the fluorescence light and side scatter light signal, direct it to a second end of the optical fibre, and launch it out of the second end; and
a fluorescence detector array located near the second end of the optical fibre to receive the remaining portion of the fluorescence light and side scatter light signal, the fluorescence detector array including a plurality of mirrors, a plurality of filters, and a plurality of photodetectors to detect respective wavelength portions of a wavelength bandwidth in the fluorescence light and side scatter light signal.

24. The electro-optic imaging system of claim 21, further comprising:
a mask over the linear array detector, the mask having a linear slot to allow a line of light to pass through onto the plurality of photodetectors in the linear array detector.

25. The electro-optic imaging system of claim 24, further comprising:
a bandpass light filter over the linear slot of the mask, the bandpass light filter to selectively choose a wavelength bandwidth range to pass through into the linear slot and onto the plurality of photodetectors in the linear array detector.

26. The electro-optic imaging system of claim 25, wherein:
the plurality of photodetectors in the linear array detector are avalanche photo diodes (APD).
